(19) United States
(12) Patent Application Publication
(10) Pub. No.: US 2026/0149774 A1
(43) Pub. Date: May 28, 2026

(54) IMAGE PROCESSING APPARATUS, METHOD EXECUTED BY IMAGE PROCESSING APPARATUS, AND STORAGE MEDIUM

(71) Applicant: CANON KABUSHIKI KAISHA, Tokyo (JP)

(72) Inventor: YOKO TAKENAKA, Chiba (JP)

(21) Appl. No.: 19/377,596

(22) Filed: Nov. 3, 2025

(30) Foreign Application Priority Data
Nov. 26, 2024 (JP) 2024-205530

(51) Int. Cl. H04N 1/00

(52) U.S. Cl. CPC H04N 1/00076; H04N 1/00029; H04N 1/00413; H04N 1/00477; H04N 2201/0094

(57) ABSTRACT

An image processing apparatus manages a history of states of the image processing apparatus and a history of a usage status of the image processing apparatus, and performs display processing to display, on a display unit, a screen including an information display region that displays either first information indicating an abnormality among the states of the image processing apparatus or second information indicating a history of the usage status of the image processing apparatus, a first operation region that accepts an operation to switch between display of the first information and display of the second information, and a second operation region that accepts an operation to select the first information within the information display region. In the display processing, in a case in which the operation to the first operation region is accepted in a state in which both the first information is displayed and the operation to the second operation region has been accepted, third information indicating the first information in a time series and the second information are displayed on a single time series within the information display region.

### BACKGROUND

### Field

The present disclosure relates to technology for display of information in an image processing apparatus.

### Description of the Related Art

Maintenance work of an image processing apparatus (or an image forming apparatus) is performed periodically or at times as needed. In maintenance work, information of the image processing apparatus is necessary in order to determine causes of faults. For example, in fault handling in a case in which jams of recording paper occur frequently, information such as the paper feed tray that causes the frequent jams, recording paper type, occurrence location, and installation environment, and the like, becomes necessary, and handling methods change depending on the content of the information necessary for the maintenance. Accordingly, technology that provides fault information and apparatus information related to faults for service personnel who perform maintenance work is known. For example, the image processing apparatus displays parts life and information at a time of occurrence of errors and jams as fault information, and displays values of temperature and humidity and cassette operation history as apparatus information.

Japanese Patent Application Laid-Open No. 2023-91722 describes technology in which error information acquired from an image forming apparatus and information indicating error resolution methods input to the image forming apparatus (or an information processing apparatus capable of communicating with the image forming apparatus) and the like are displayed by associating time information with each piece of information. Information indicating error resolution methods is, for example, a message (text data) indicating error resolution methods input to the image forming apparatus and the like by an operator. Time information corresponding to the error resolution methods is, for example, a time at which the message was input. As specific examples of the error resolution methods, cleaning and replacement of parts and the like are exemplified.

In Japanese Patent Application Laid-Open No. 2023-91722, displaying error information and error resolution methods of the error by associating time information with each of the error information and the error resolution methods is effective in that a user can identify resolution methods from past errors. However, it is difficult for service personnel to analyze causes of abnormalities such as new errors and to identify resolution methods.

### SUMMARY

The present disclosure provides a technique that makes it possible to easily perform analysis of abnormalities that occur in an image processing apparatus.

According to one embodiment of the present disclosure, an image processing apparatus having a display unit comprises: a memory storing instructions; and a processor executing the stored instructions causing the image processing apparatus to manage a history of states of the image processing apparatus and a history of usage status of the image processing apparatus, and perform display processing to display, on the display unit, a screen including an information display region that displays either first information indicating an abnormality among the states of the image processing apparatus or second information indicating a history of the usage status of the image processing apparatus, a first operation region that accepts an operation to switch between display of the first information and display of the second information, and a second operation region that accepts an operation to select the first information within the information display region. Then, in the display processing, in a case in which an operation to the first operation region is accepted in a state in which the first information is displayed and an operation to the second operation region has been accepted, third information indicating the first information in a time series and the second information are displayed on a single time series within the information display region.

Further features of the present disclosure will become apparent from the following description of exemplary embodiments (with reference to the attached drawings).

### BRIEF DESCRIPTION OF THE DRAWINGS

FIG. 1 is a diagram showing a configuration of a system having an image processing apparatus according to a First Embodiment.

FIG. 2 is a block diagram showing a hardware configuration of the image processing apparatus.

FIG. 3 is a block diagram showing an example of processing functions related to the present embodiment.

FIG. 4 is a diagram showing an example of a top screen in a case in which an abnormality exists in the image processing apparatus.

FIG. 5 is a diagram showing an example of a top screen in a case in which no abnormality exists in the image processing apparatus.

FIG. 6 is a diagram showing a parts life screen.

FIG. 7 is a diagram showing a state details screen.

FIG. 8 is a diagram showing a fault detection screen.

FIG. 9 is a diagram showing a contamination details screen.

FIG. 10 is a diagram showing an error screen.

FIG. 11 is a diagram showing an error details screen.

FIG. 12 is a diagram showing a jam screen.

FIG. 13 is a diagram showing a jam details screen.

FIG. 14 is a diagram showing a temperature change screen.

FIG. 15 is a diagram showing a humidity change screen.

FIG. 16 is a diagram showing a print count screen.

FIG. 17 is a diagram showing a cassette history screen.

FIG. 18 shows history data used for displaying information of parts life.

FIG. 19 shows history data used for displaying information of fault detection.

FIG. 20 shows history data used for displaying information of errors.

FIG. 21 shows history data used for displaying information of jams.

FIG. 22 shows temperature data used for displaying information of temperature changes.

FIG. 23 shows humidity data used for displaying information of humidity changes.

FIG. 24 shows print count data used for displaying print count information.

FIG. 25 shows cassette operation data used for displaying cassette history information.

FIG. 26 is a flowchart showing an example of display processing of a top screen that includes activation processing of a state monitor.

FIG. 27 is a flowchart showing a continuation of FIG. 26.

FIG. 28 is a flowchart showing a continuation of FIG. 27.

FIG. 29 is a flowchart showing an example of display processing of a usage status screen in a Second Embodiment.

FIG. 30 is an example of a usage status screen displayed in step S2912 in the Second Embodiment.

FIG. 31 is another example of a usage status screen displayed in step S2912 in the Second Embodiment.

FIG. 32 is an example of a usage status screen displayed by selecting the temperature button from a state in which the screen of FIG. 31 is displayed.

### DESCRIPTION OF THE EMBODIMENTS

Hereinafter, embodiments of the present disclosure will be explained with reference to the drawings. Not all of the plurality of features in the embodiments of the present disclosure are necessarily essential, and the plurality of features may be arbitrarily combined. In addition, configurations shown in the following embodiments are merely examples, and the present disclosure is not limited to the illustrated configurations. By assigning identical reference numerals to identical or similar configurations in the drawings, redundant explanation is omitted.

### First Embodiment

### System Configuration

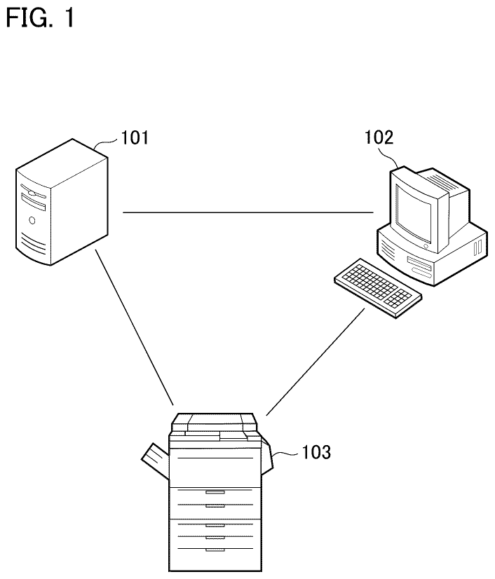

FIG. 1 is a diagram showing a configuration of a system having an image processing apparatus according to an embodiment. The system of the present embodiment includes an image processing apparatus 103, a server PC (Personal Computer) 101, and a client PC 102. The image processing apparatus 103, the server PC 101, and the client PC 102 are connected to one another via a network.

The network refers to a communication network that is realized by any of, or by a combination of, for example, a LAN, a WAN, a telephone line, a dedicated digital line, ATM, a frame relay line, a cable television line, a wireless line for data broadcasting, and the like. A plurality of image processing apparatuses 103 may be installed in a single local area.

The image processing apparatus 103 is a Multi-Function Peripheral (MFP). That is, the image processing apparatus 103 is provided with a print function, a copy function, a facsimile transmission function, a scan function, and the like. The image processing apparatus 103 not only has a function for copying paper originals but also has a function for printing print data sent from an external printer driver. In addition, the image processing apparatus 103 has a function (SEND function) for reading paper originals and sending image data of the paper originals to an external file server or to an email address. Furthermore, the image processing apparatus 103 has functions including a function for sending data to another image processing apparatus and printing at the destination image processing apparatus (remote copy function and facsimile transmission function), and the like.

Although the image processing apparatus 103 is assumed to be connected via Ethernet (not shown), the connection via Ethernet is merely an example. All information processing apparatuses (the server PC 101 and the client PC 102) other than the image processing apparatus 103 may be configured by the same computer. Alternatively, by the information processing apparatuses being implemented in the image processing apparatus 103, the system may be configured by the image processing apparatus 103 alone. Information processing apparatuses used in the present embodiment need not be PCs and may be terminal devices other than PCs or a smartphone. A printing method of the image processing apparatus 103 used in the present embodiment may be an electrophotographic method or an inkjet method, or may be another method.

### Hardware Configuration of Image Processing Apparatus

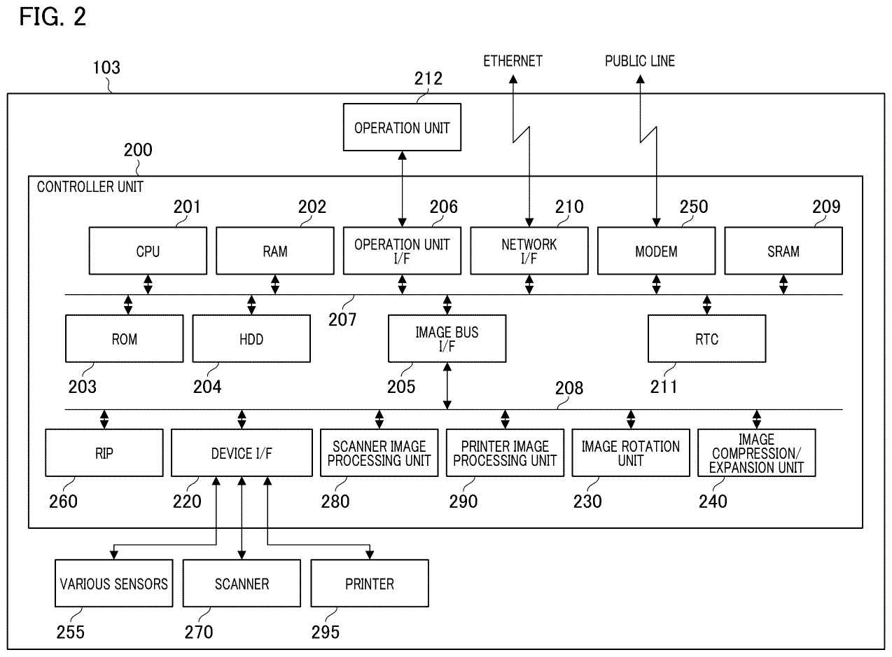

FIG. 2 is a block diagram showing a hardware configuration of the image processing apparatus 103. The image processing apparatus 103 is provided with a controller unit 200, an operation unit 212, various sensors 255, a scanner 270, and a printer 295.

The controller unit 200 is connected to the scanner 270 that is an image input device and to the printer 295 that is an image output device, and, by being connected to Ethernet or a public line, the controller unit 200 performs input and output of image information and device information.

The controller unit 200 has a CPU 201, a RAM 202, a ROM 203, an HDD (hard disk drive) 204, and an operation unit I/F 206. In addition, the controller unit 200 has a network I/F 210, a modem 250, an SRAM 209, an image bus I/F 205, and an RTC (real-time clock) 211. Each of the units is connected to a system bus 207.

Furthermore, the controller unit 200 has a RIP (raster image processor) 260, a device I/F 220, a scanner image processing unit 280, a printer image processing unit 290, an image rotation unit 230, and an image compression/expansion unit 240. Each of the units is connected to an image bus 208.

The CPU 201 is a controller that controls the image processing apparatus 103. The RAM 202 is a system work memory for operation of the CPU 201, and is also an image memory for temporarily storing image data. The ROM 203 is a boot ROM, in which the system boot program is stored. The HDD 204 stores system software, applications, and image data.

It should be noted that use is not limited to the CPU 201, and that a PLD (Programmable Logic Device) such as an FPGA (Field Programmable Gate Array) may be used. Alternatively, an ASIC (Application Specific Integrated Circuit) may be used, or a DSP (Digital Signal Processor) may be used. In addition, an apparatus that has a storage medium other than the HDD 204 may be used. The storage medium other than the HDD 204 refers to, for example, flash memory, an SSD (Solid State Drive), an optical storage medium, or a magneto-optical storage medium, and the like.

The operation unit I/F 206 is an interface unit that interfaces with the operation unit 212 that includes a touch panel, and outputs image data for display on the operation unit 212 to the operation unit 212. In addition, the operation unit I/F 206 conveys information input by a user from the operation unit 212 to the CPU 201. The network I/F 210 connects to a network and performs input and output of information.

The modem 250 connects to a public line and performs input and output of information. The SRAM 209 is a nonvolatile storage medium capable of high-speed operation. The RTC 211 performs processing to continue counting the current time even in a state in which power to the controller unit 200 is not supplied.

The image bus I/F 205 is a bus bridge that connects the system bus 207 and the image bus 208 that transfers image data at high speed, and converts data structures. The image bus 208 is configured by, for example, a PCI bus or IEEE 1394.

The RIP 260 rasterizes PDL code into a bitmap image.

The device I/F 220 connects to the various sensors 255 and acquires the state of the image processing apparatus. In addition, the device I/F 220 connects the scanner 270 and the printer 295 to the controller unit 200, and performs conversion between synchronous and asynchronous systems of image data.

The scanner image processing unit 280 performs correction, processing, and editing on input image data. The printer image processing unit 290 performs correction (printer correction), resolution conversion, and the like on print output image data. The image rotation unit 230 performs rotation of image data. The image compression/expansion unit 240 performs compression and expansion processing of images.

### Software Configuration of Image Processing Apparatus

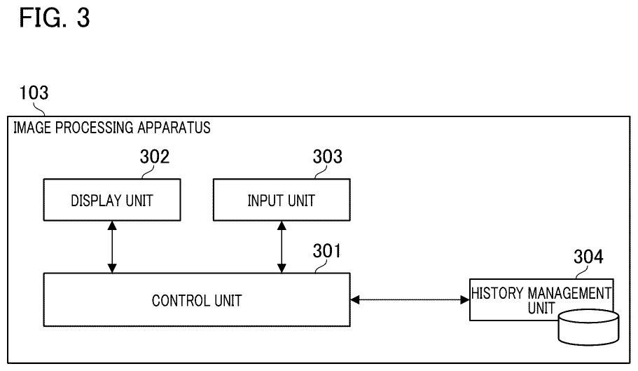

FIG. 3 is a block diagram showing, among the units in the image processing apparatus 103, an example of processing functions that show functions related to the present embodiment. As shown in the explanation of FIG. 2, the functions of function units explained hereinafter and processing related to flowcharts described later are realized by the CPU 201 executing a part or all of the program on the RAM 202 based on the program stored in the ROM 203.

A display unit 302 displays the state of the image processing apparatus 103 and operation menus on the operation unit 212. An input unit 303 accepts operation instructions from a user. A history management unit 304 processes information and stores, in a history database, respective information of a history of the state of the image processing apparatus 103 and a history of a usage status of the image processing apparatus 103. The history management unit 304 is an example of a management unit that manages the history of the state of the image processing apparatus 103 and the history of the usage status of the image processing apparatus 103. As described later, the state of the image processing apparatus 103 refers to, for example, parts life, fault detection, errors, and jams. As described later, the usage status of the image processing apparatus 103 refers to, for example, temperature, humidity, print count, and cassette history.

A control unit 301 controls the display unit 302, the input unit 303, and the history management unit 304. The control unit 301, or mainly the CPU 201 and the like, is an example of a processing unit that, based on information of the respective histories of the state and the usage status that are managed by the history management unit 304, mainly performs display processing to the display unit 302.

### Screen Configuration According to an Embodiment

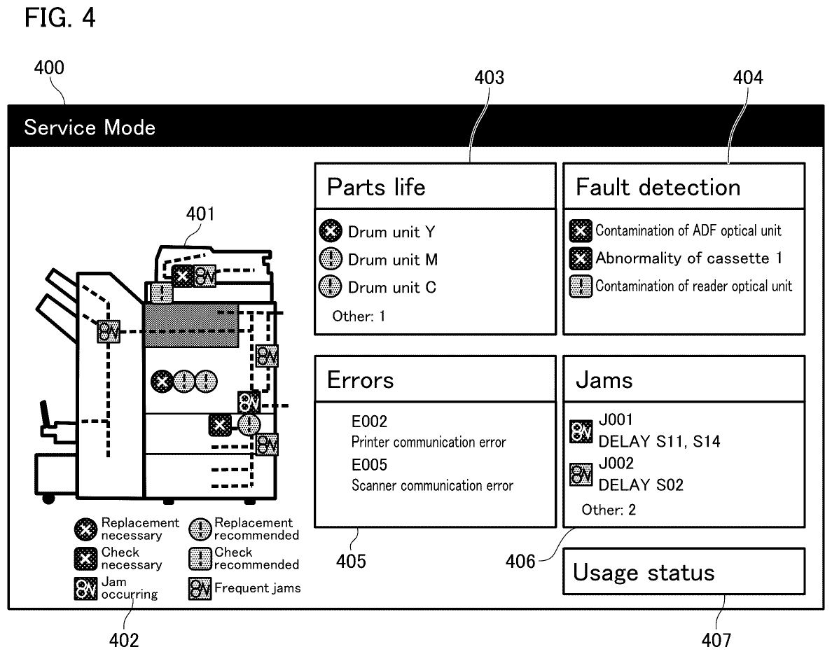

Next, a state monitor screen that displays the state and history of the image processing apparatus 103 for service personnel is explained with reference to FIGS. 4 to 15. Although the state monitor screen is a screen that is displayed on the operation unit 212 of the image processing apparatus 103, because the state monitor screen is not intended for general users, the state monitor screen is activated only through special operations. In addition, respective screen data explained in FIGS. 4 to 15 are displayed based on data recorded in the history management unit 304.

FIG. 4 is a diagram showing an example of a top screen 400 in a case in which an abnormality exists in the image processing apparatus 103. The display unit 302 displays, by icons (icon images), an occurrence location of an abnormality of the image processing apparatus and a type of the abnormality, mapped onto the cross-sectional diagram 401 of the image processing apparatus. Paper transport paths are also shown in the cross-sectional diagram 401, and service personnel can know whether an abnormality is likely to affect use of main functions of the image processing apparatus such as scanning and printing. Although the paper transport paths are shown by broken lines in the cross-sectional diagram 401, the paper transport paths may be shown by other lines or diagrams.

A legend 402 of abnormality types shows types and contents of icons that are mapped for display onto the cross-sectional diagram 401. The types indicate whether replacement of parts for which deterioration has progressed is required, whether checking is necessary due to occurrence of a fault, and whether there are locations at which jams are occurring or occurring frequently, and the like. Information of abnormalities (contents, types, and the like) and coordinates of abnormality occurrence locations on the cross-sectional diagram 401 are predetermined in a one-to-one or many-to-one relationship.

Each area in which parts life 403, fault detection 404, errors 405, and jams 406 are displayed is a notification area that displays (notifies) abnormality information that is occurring in the image processing apparatus 103. These notification areas include buttons for proceeding to detail screens, and, for example, an entire notification area is an operation region that accepts operation by a user. Although a usage status button 407 is, as described above, an operation region that accepts operation by a user in order to display usage status, the usage status button 407 does not include a notification area.

Because content that is displayable in each notification area is restricted by the screen region, abnormalities are displayed from the top in order of higher priority, and, in a case in which all abnormalities cannot be displayed, the number of remaining abnormalities is displayed as “Other”. In contrast, on the cross-sectional diagram 401, both icons indicating display targets and icons indicating non-display targets are displayed.

In addition, on the top screen 400, among abnormality information, abnormality information not displayed on the cross-sectional diagram 401 and in which a location within the image processing apparatus 103 cannot be identified may also be displayed. As abnormality information in which a location within the image processing apparatus 103 cannot be identified, examples include system errors and the like. Such abnormality information for which a location within the image processing apparatus 103 cannot be identified may, for example, be notified as the errors 405 category, or may be notified as another category not explained here.

Priority is set for abnormality information, and the order of priority is predetermined. Abnormality information includes, for example, abnormalities requiring handling and abnormalities for which handling is recommended. The priority of abnormalities requiring handling is set higher than the priority of abnormalities for which handling is recommended. For example, with respect to the priority of parts life 403, “replacement necessary” is set higher than “replacement recommended”, and, in a case in which levels are the same, the order follows the arrangement order of the parts life screen described later.

With respect to the priority of fault detection 404, “check necessary” is set higher than “check recommended”, and, in a case in which levels are the same, the order follows the arrangement order of the fault detection screen described later.

In the errors 405, errors that are currently occurring are displayed in descending order of occurrence date and time. With respect to the errors 405, the descending order of occurrence date and time may be set as the priority order, or the ascending order of occurrence date and time may be set as the priority order. Alternatively, the order of priority may be set according to other criteria.

With respect to the priority of jams 406, “jam occurring” (abnormalities requiring handling) is set higher than “frequent jams” (abnormalities for which handling is recommended), and, in a case in which levels are the same, similar to the jam screen described later, the abnormality information is displayed in descending order of occurrence date and time. It should be noted that the priority of abnormality information in each category may be set in three or more stages.

The parts life 403, in the example of FIG. 4, indicates by icons corresponding to the legend 402 that replacement of the drum unit Y is necessary, and that replacement timing is approaching for the drum unit M and the drum unit C (replacement recommended). In addition, the parts life 403 also indicates in “Other” that there is one part for which the life limit is near, that is, for which the usage limit is near. When the notification area of the parts life 403 (or the band-shaped button at an upper portion of the notification area that is marked “Parts life”) is pressed, transition is made to the parts life screen described later.

With respect to abnormality information, in a case in which a plurality of pieces of abnormality information that correspond to the same location on the cross-sectional diagram 401 exist, an icon that corresponds to an abnormality of high priority (highest priority) is displayed.

The fault detection 404, in the example of FIG. 4, indicates by icons that there are two “check necessary” and one “check recommended”. When the notification area of the fault detection 404, or a button at an upper portion of the notification area of the fault detection 404, is pressed, transition is made to the fault detection screen described later.

With respect to the errors 405, in the example of FIG. 4, two errors that are currently occurring are indicated by icons. Icons are not displayed on the cross-sectional diagram 401 for the errors 405 because many system-related errors cannot be definitively determined at a specific position on the cross-sectional diagram 401. When the notification area of the errors 405 or a button at an upper portion of the notification area of the errors 405 is pressed, transition is made to the error screen described later.

The jams 406, in the example of FIG. 4, indicate by icons that there is one jam occurring, one frequent jam, and two other notifications. When the notification area of the jams 406, or a button at an upper portion of the notification area of the jams 406, is pressed, transition is made to the jam screen described later.

The usage status button 407 is a button for proceeding to the usage status screen described later.

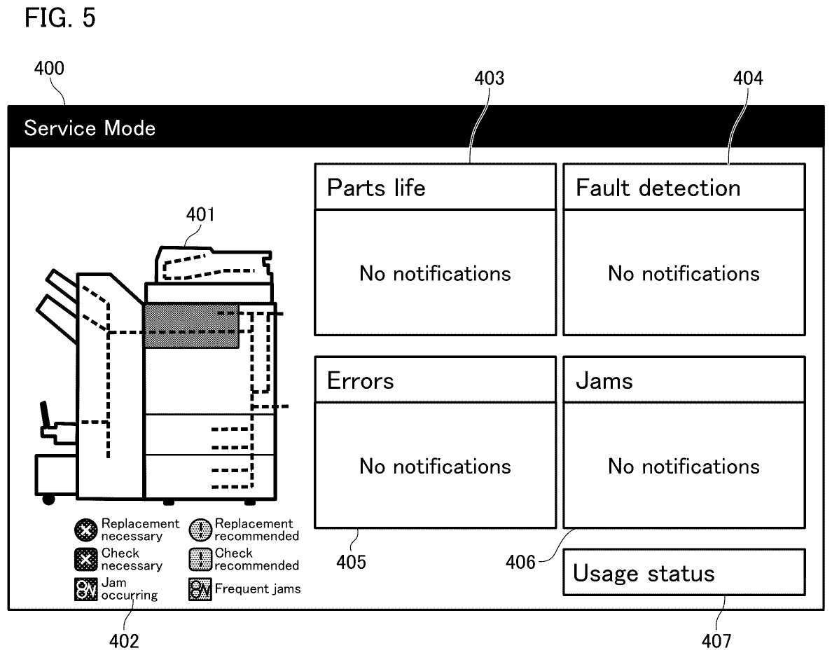

FIG. 5 is a diagram showing an example of the top screen 400 in a case in which no abnormalities exist in the image processing apparatus 103. Because no abnormalities exist, no icons of the legend 402 are displayed on the cross-sectional diagram 401. “No notifications” is displayed in each notification area (403 to 406), and service personnel can recognize at a glance that no abnormalities exist. In this manner, because service personnel can obtain, from the top screen 400, the presence or absence of abnormalities of the entire image processing apparatus or the occurrence locations of abnormalities and the content of the abnormalities, service personnel can identify locations that should be handled promptly and can immediately begin work. In addition, service personnel can consider efficient work procedures such as collectively handling abnormalities at locations that are close to each other on the cross-sectional diagram 401.

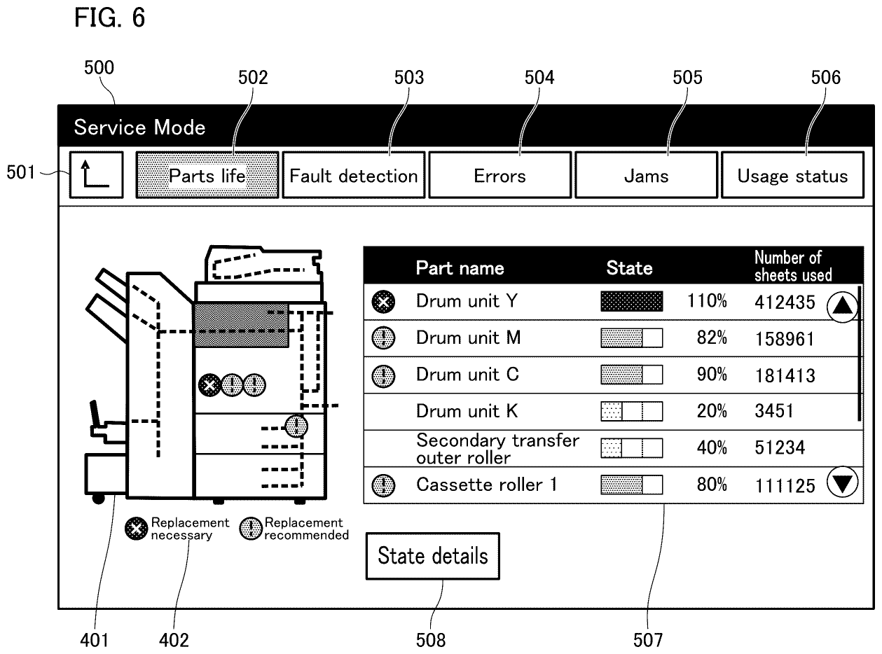

FIG. 6 is a diagram showing a parts life screen 500 that is displayed by the parts life 403 of the top screen 400 described above being pressed. At an upper portion of the screen, a return button 501, a parts life button 502, a fault detection button 503, an errors button 504, a jams button 505, and a usage status button 506 are displayed as buttons for switching screens. The return button 501 is a button for returning to the top screen. When the fault detection button 503, the errors button 504, the jams button 505, or the usage status button 506 is pressed, transition is made to the respective detail screen. Because the buttons 501 to 506 are also displayed in each detail screen described later, service personnel can easily go back and forth among the detail screens. Accordingly, work of estimating causes of abnormalities by comparing information displayed in each screen becomes easier.

Although the parts life screen 500 also displays the cross-sectional diagram 401 and the legend 402, the icons displayed are limited to parts.

A parts list 507 displays a list indicating states of replacement parts. In the respective columns of the parts list 507, for components (that is, parts), “part name,” “state,” and “number of sheets used” of paper that has been fed (used) after replacement of the part are displayed.

In the parts list 507, “State” is displayed as a level meter icon having four levels according to a state value of a part. For example, a level “0” indicating an indeterminate value immediately after replacement of a part, a level “1” for a state value of 0 to 79%, a level “2” for 80 to 99%, and a level “3” for 100% or higher are displayed, respectively, by level meter icons. In addition, on the right side of the level meter, the current state value is also displayed as a numeric value. This state value is preset so that the state value increases as deterioration of a part progresses, and so that 100% is the value at which replacement becomes necessary. As parameters used to calculate the state value, for example, the number of sheets used after replacement and current values and resistance values of the respective parts, and the like, are used.

In a case in which the level of the state value is “2”, a replacement recommended icon is displayed at the left edge of the list, indicating that a usage limit of a relevant part is approaching. In the example of FIG. 6, “drum unit M,” “drum unit C,” and “cassette roller 1” are in a state in which replacement is recommended. In a case in which the level of the state value is “3”, a replacement necessary icon is displayed on the left side of the list, indicating that a relevant part has reached a usage limit. In the example of FIG. 6, “drum unit Y” is in a state in which replacement is necessary.

In a case in which service personnel replace a part, by detection of replacement of the part, the state value returns once to level “0” (no data). Therefore, on the cross-sectional diagram 401 and the parts list 507, icons for replacement necessary and replacement recommended of the replaced part are not displayed. Unlike the notification area of parts life 403 on the top screen 400, the parts list 507 displays all parts that are managed by service personnel regardless of the presence or absence of abnormalities. Therefore, state values of parts not yet requiring replacement can also be confirmed. The parts list 507 can display states of all parts by being scrolled up and down.

A state details button 508 is a button for proceeding to a screen that displays, in a graph, transitions of a state value of a part selected in the parts list 507.

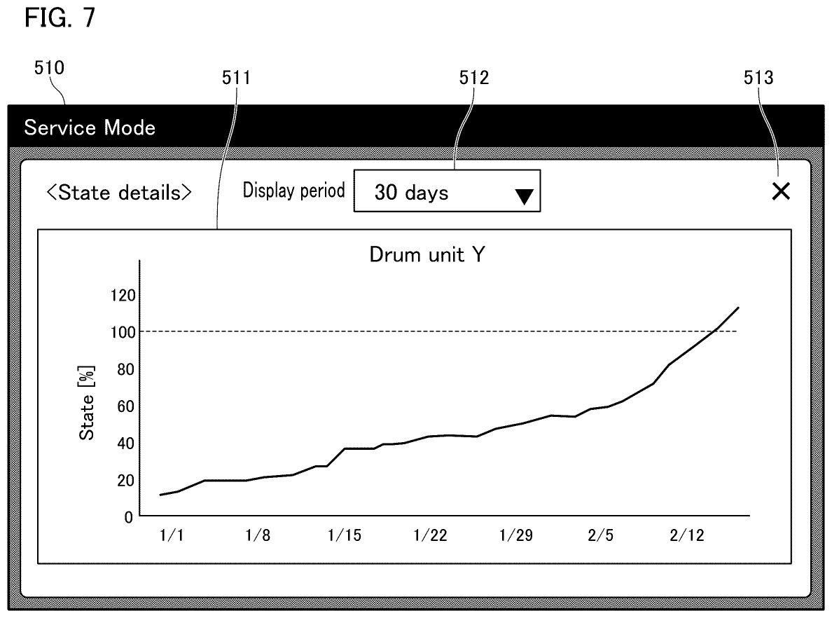

FIG. 7 is a diagram showing a state details screen 510 displayed by the state details button 508 being pressed. A state transition graph 511 shows the day-by-day transition of the state value of the selected part. On the graph, a reference line is displayed at 100%, at which replacement of the part becomes necessary. A display period 512 is a pull-down menu for switching the display period of the graph between 30 days and 180 days. The display period 512 is not limited to 30 days and 180 days. A close button 513 is a button for closing the state details screen 510 and returning to the parts life screen 500.

In the example of FIG. 7, the state transition graph 511 for “drum unit Y” of the parts life screen 500 is shown, and the day-by-day transition until the state value exceeded 100% can be seen. Thereby, service personnel can estimate whether deterioration progressed as assumed, or whether deterioration of the part progressed rapidly due to a defect of the part or an environmental change. Although the example of FIG. 7 shows a case in which the state value exceeded the usage limit of the part, in a case in which the part has not yet reached the usage limit, service personnel can predict from the slope of the graph approximately how many days until the part reaches the usage limit. Thereby, service personnel can determine whether to bring a replacement part at the next visit and can prepare replacement parts.

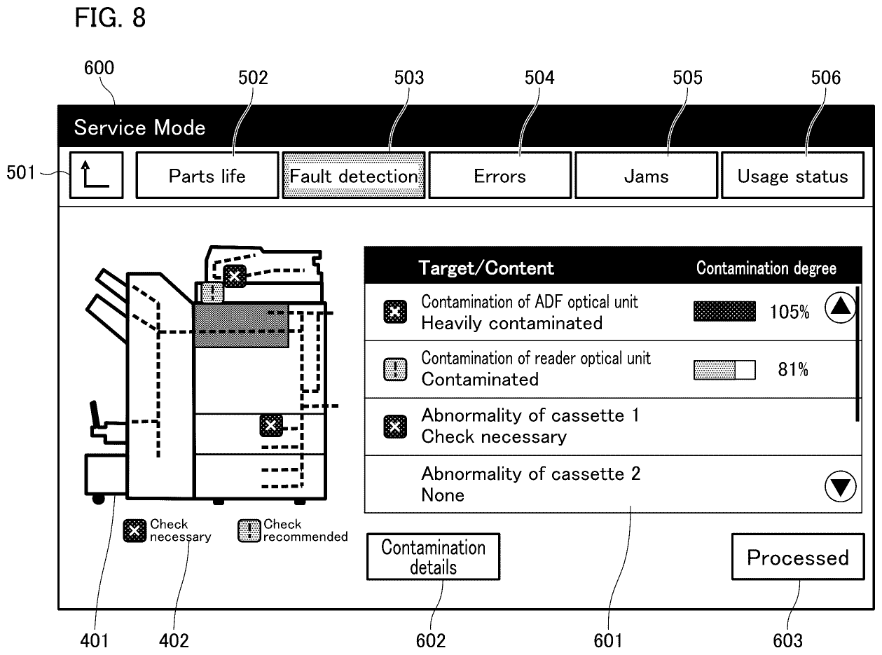

FIG. 8 is a diagram showing a fault detection screen 600 that is displayed by the fault detection 404 of the top screen 400 being pressed, or by the fault detection button 503 of each detail screen being pressed. Buttons 501 to 506 arranged at the upper portion of the screen have functions similar to the buttons 501 to 506 shown in FIG. 6.

Although the fault detection screen 600 also displays the cross-sectional diagram 401 and the legend 402, with respect to the icons that are displayed, display is limited to icons indicating whether fault checking is necessary.

A fault list 601 displays a list indicating fault targets that frequently require handling by service personnel and the content of the fault targets. “ADF optical unit contamination” and “reader optical unit contamination” display information indicating whether cleaning of the optical unit is necessary. “ADF” is an abbreviation for Automatic Document Feeder. For example, a degree of contamination of a mirror is detected from values of reflected light of the mirror acquired by an optical sensor and the like. Similar to the state value and the state level of parts life described above, a contamination degree [%], with 100% as a reference value at which cleaning becomes necessary, and a contamination level that is an icon of a four-level level meter according to the contamination degree, are displayed. Based on the contamination degree or the contamination level, information indicating whether a measure is necessary is displayed.

Specifically, for example, in a case in which the contamination degree is indeterminate, a level “0” icon is displayed. In a case in which the contamination degree is 0 to 79%, a level “1” icon is displayed. In a case in which the contamination degree is 80 to 99%, a level “2” icon is displayed. In a case in which the contamination degree is 100% or higher, a level “3” icon is displayed. In a case in which the contamination level is “2”, a check recommended icon indicating that cleaning is recommended is displayed at the left edge of the list. In a case in which the contamination level is “3”, a check necessary icon indicating that cleaning is necessary is displayed at the left edge of the list.

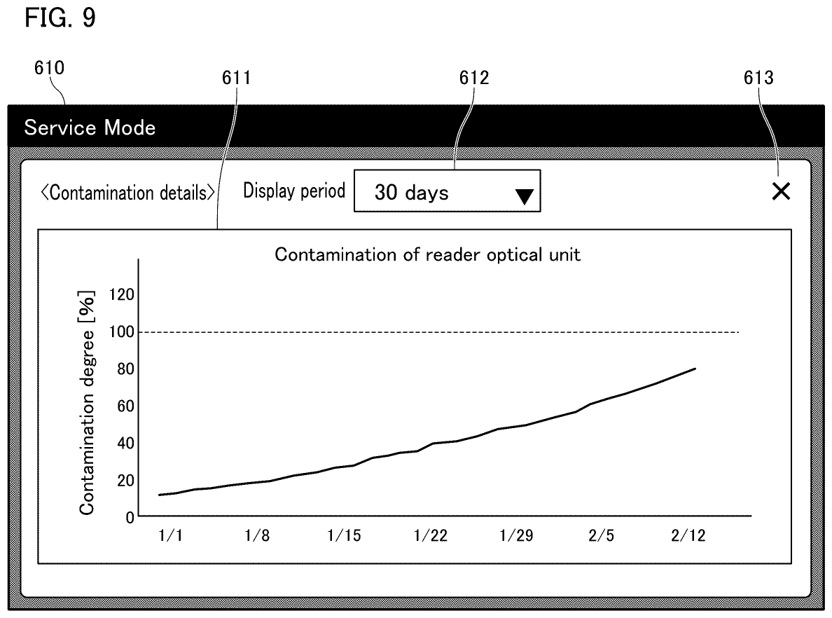

In addition, messages relating to the fault items and the content of the fault items in the fault list 601 are switched according to the level. For example, level “0” displays “No data,” level “1” displays “Good,” level “2” displays “Contaminated,” and level “3” displays “Heavily contaminated.” With respect to contamination of optical units, by one item in the fault list 601 being selected and by the contamination details button 602 being pressed, a graph of transitions of the contamination degree (explained later in FIG. 9) can be confirmed.

In the fault list 601, with respect to cassette abnormalities, whether an abnormality exists in each cassette and the content of the abnormality are displayed. Mainly, in a case in which misalignment of paper regulating plates (guides) in the cassette is detected, a determination is made that an abnormality is occurring in the cassette. In a case in which a cassette abnormality exists, “Confirmation necessary” is displayed in the list, and in a case in which no abnormality exists, “None” is displayed.

A processed button 603 is a pressable button in a case in which an optical unit or a cassette is in a “check necessary” or “check recommended” state. In a case in which, after cleaning of the optical unit, the target optical unit in the fault list 601 is selected and the processed button 603 is pressed by service personnel, the contamination level returns to “0”. As a result, “check necessary” or “check recommended” icons are no longer displayed on the cross-sectional diagram 401 and in the fault list 601. In addition, in a case in which, after confirmation of the cassette, the target cassette in the fault list 601 is selected and the processed button 603 is pressed by service personnel, display returns to a display indicating no abnormality. As a result, “check necessary” icons are no longer displayed on the cross-sectional diagram 401 and in the fault list 601.

FIG. 9 is a diagram showing a contamination details screen 610 that is displayed by pressing the contamination details button 602 for an optical unit. A contamination transition graph 611 shows day-by-day transitions of the contamination degree of the target optical unit selected in the fault list 601. A reference line is displayed at 100%, indicating that cleaning becomes necessary at 100%. A display period 612 is a pull-down menu for switching the display period of the graph between 30 days and 180 days. A close button 613 is a button for closing the contamination details screen 610 and returning to the fault detection screen 600.

In the example of FIG. 9, the contamination transition graph 611 of “reader optical unit contamination” of the fault detection screen 600 is shown, and daily transitions until reaching “check recommended” at a contamination degree of 81% can be seen. From the slope of this graph, service personnel can predict approximately how many days remain until a level at which cleaning becomes necessary is reached. Thereby, service personnel can determine whether to bring cleaning tools at the next visit and can make preparations.

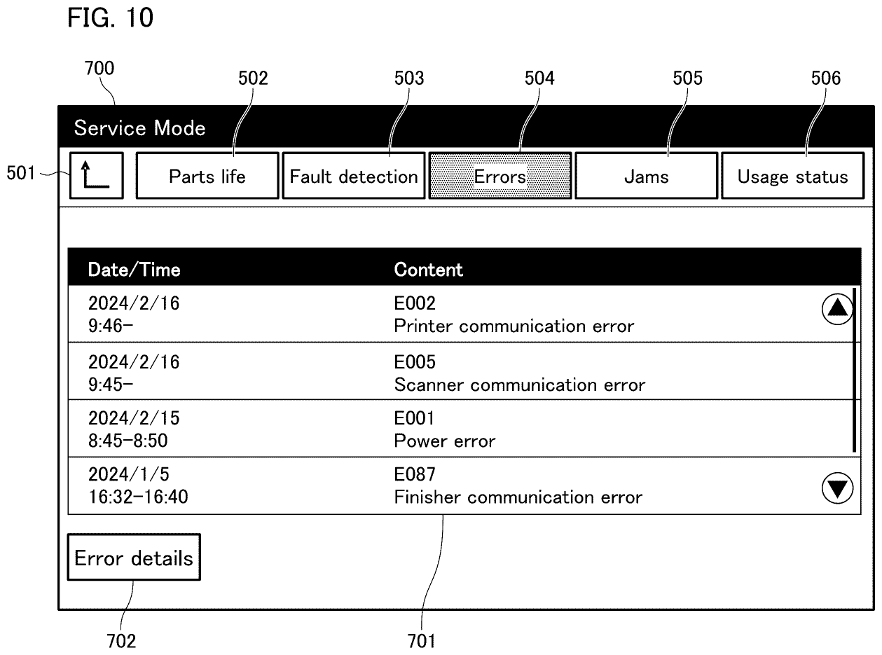

FIG. 10 is a diagram showing an error screen 700 that is displayed by the errors 405 of the top screen 400 being pressed, or by the errors button 504 of each detail screen being pressed. Buttons 501 to 506 arranged at an upper portion of the screen have functions similar to the buttons 501 to 506 shown in FIG. 6 and FIG. 8.

An error list 701 displays a list of histories of errors that occurred in the image processing apparatus 103. In the error list 701, for each error, an occurrence date, an occurrence time, and a recovery time are displayed, and, as content, an error code and an error title are displayed. The errors in the first and second lines lacking a recovery time display indicate errors that are currently occurring. For example, by one target in the error list 701 being selected and by an error details button 702 being pressed, detailed information of the selected target error can be confirmed.

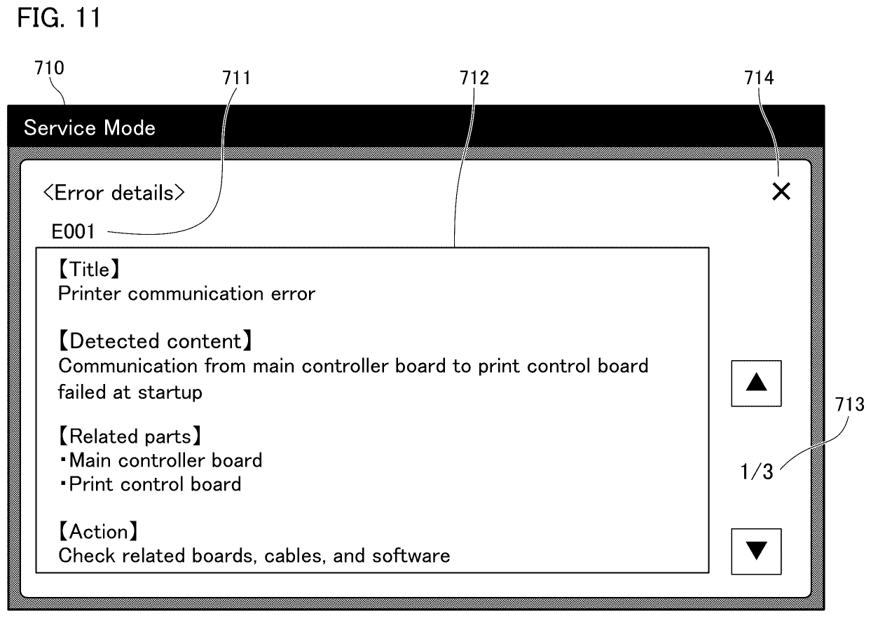

FIG. 11 is a diagram showing an error details screen 710 that is displayed by pressing the error details button 702. An error code 711 indicates an error code that identifies the selected error. In error information 712, an error title, a description, and a handling method are displayed. A page-forward button 713 is a button for switching pages in a case in which the error information has a plurality of pages. A close button 714 is a button for closing the error details screen 710 and returning to the error screen 700. From the error details screen 710, service personnel can confirm errors that are currently occurring and the content of the errors.

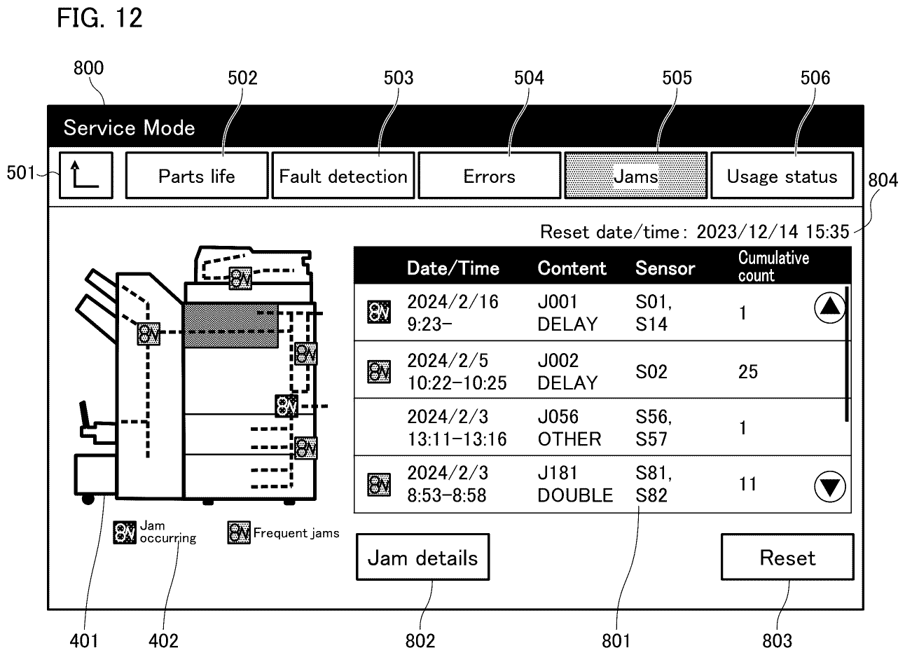

FIG. 12 is a diagram showing a jam screen 800 that is displayed by pressing the jams 406 of the top screen 400, or by pressing the jams button 505 of each detail screen. Buttons 501 to 506 arranged at an upper portion of the screen have functions similar to the buttons 501 to 506 shown in FIGS. 6, 8, and 10.

Although the jam screen 800 also displays the cross-sectional diagram 401 and the legend 402, with respect to icons that are displayed, display is limited to icons indicating either a jam that is occurring or a frequently occurring jam.

A jam list 801 displays a list of jam histories. In the jam list 801, for each jam, an occurrence date, an occurrence time, and a recovery time are displayed, and, as content, a jam code, a jam type, a sensor number, and a cumulative count of the same jam code are displayed. The jam in the first line lacking a display of a recovery time indicates a jam occurring, and an icon indicating a jam occurring is displayed at the left edge of the jam list 801. Jams having a cumulative count equal to or greater than a predetermined number, as in the jam histories in the second and fourth lines, are determined to be frequent jams, and an icon indicating frequent jams is displayed at the left edge of the list. In the example of FIG. 12, jams that occurred ten times or more are determined to be frequent jams. In a case in which a plurality of histories of the same jam code exist, only the most recent one is displayed in the list. Thereby, types of jams that have occurred become easier to grasp. By one target in the jam list 801 being selected and by a jam details button 802 being pressed, detailed information of the selected target jam can be confirmed.

A reset button 803 is a button for clearing jam histories being displayed. Service personnel use the reset button 803 in a case in which confirmation of a jam occurring or frequent jams is completed and deletion of notifications is desired. When the reset button 803 is pressed, the reset date and time 804 is updated, and, in the jam list 801, jam histories on and after the reset date and time 804 are displayed.

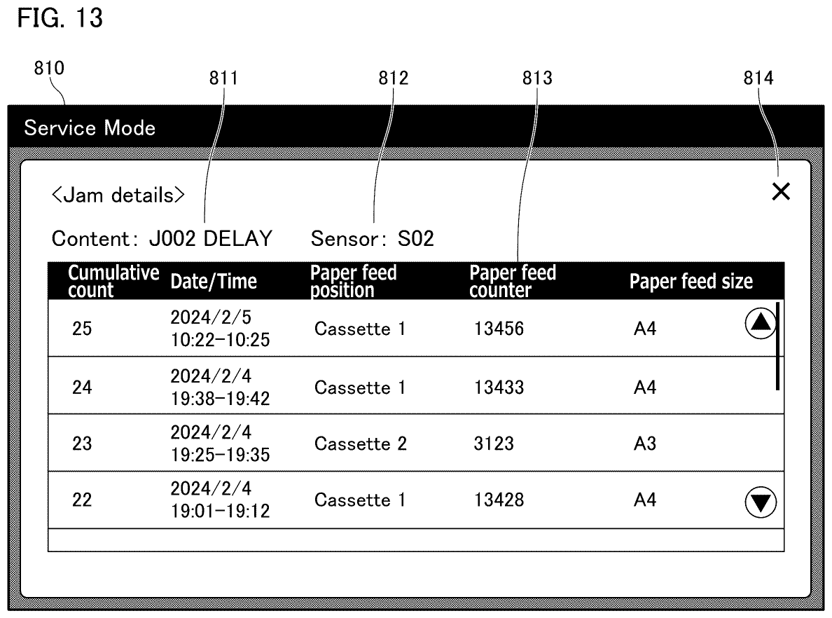

FIG. 13 is a diagram showing a jam details screen 810 that is displayed by pressing the jam details button 802. In jam content 811, the jam code and the jam type of the target jam selected in the jam list 801 are displayed. The sensor number 812 displays a sensor number related to the jam code and the occurrence location of the jam.

The jam details list 813 displays, in descending chronological order, histories of jams having the same jam content 811 (that is, a jam code and a jam type). The jam details list 813 displays a cumulative count, an occurrence date, an occurrence time, a recovery time, a paper feed position, a paper feed counter, and a paper feed size. The paper feed position is the position of the paper at the time when the jam occurred. The number indicated by “paper feed counter” is the number of sheets fed from the paper feed position at the time when the jam occurred. The paper feed size is the size of the supplied paper. Although, in the jam list 801 of FIG. 12, by aggregating histories having the same jam code into only the most recent entry for display, variations in jams that occurred are made easier to see, in the jam details list 813 of FIG. 13, a frequency of occurrence of the same jam becomes easier to see. In a case in which the number of entries is large, it is possible for the jam details list 813 to be scrolled up and down.

A close button 814 is a button for returning to the jam screen 800 by the jam details screen 810 being closed. Because service personnel can know not only jams that are occurring but also locations having many past jam occurrences and frequencies of occurrence, service personnel can consider cleaning or replacement of surrounding parts with respect to locations of jam occurrence or frequent jam occurrence.

The parts list 507, the fault list 601, the error list 701, the jam list 801, and the like are examples of first information that indicates abnormalities among states of the image processing apparatus. A temperature change graph 905, a humidity change graph 907, a print count graph 909, a cassette history list 912, and the like are second information that shows a history of usage status of the image processing apparatus. A region for displaying each of these lists is an example of an information display region. That is, in the information display region, either the above-described first information or the above-described second information is displayed.

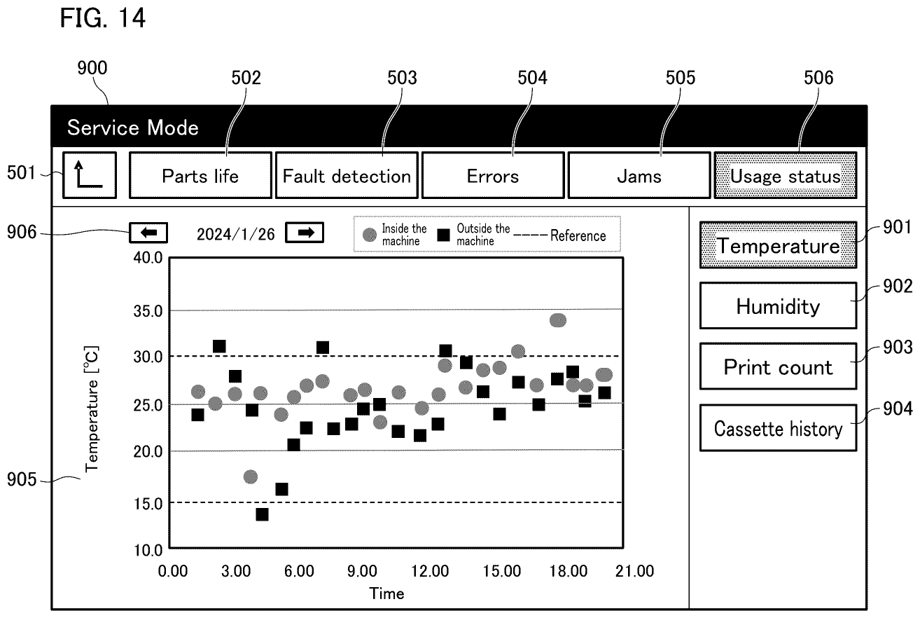

FIGS. 14 to 17 are diagrams respectively showing a usage status screen 900 that is displayed by the usage status button 407 of the top screen 400 being pressed, or by the usage status button 506 of each detail screen being pressed. At the right edge of the usage status screen 900, a temperature button 901, a humidity button 902, a print count button 903, and a cassette history button 904 for transitioning to the respective usage status screens are displayed. Because the buttons 901 to 904 are displayed in each usage status screen 900 shown in FIGS. 14 to 17, service personnel can easily go back and forth among the usage status screens 900. In addition, by using the above-described return button 501 through the usage status button 506, service personnel can easily go back and forth between the parts life screen 500, the fault detection screen 600, the error screen 700, the jam screen 800, and the usage status screen 900. Thereby, service personnel can easily compare the abnormality information and the usage status and can easily estimate causes of the abnormalities.

FIG. 14 is a diagram showing a temperature change screen that is displayed by the temperature button 901 of the usage status screen 900 being pressed. A temperature change graph 905 represents temperature (° C.) on the vertical axis and time on the horizontal axis and shows one day of temperatures inside the image processing apparatus (inside the machine) and outside the image processing apparatus (outside the machine) at 10-minute intervals. A date switching button 906 is a button for switching the date of the displayed graph. By the date switching button 906 being pressed and a date being selected, data is displayable up to one month prior.

In the temperature change graph 905, the upper limit and the lower limit are displayed as broken lines as a reference range for temperature, and, in a case in which a temperature outside the reference range is shown, a determination can be made that review of the environment is necessary. In addition, service personnel can compare the period of the temperature change screen of FIG. 14 with a period that is identical to a period in which a jam is occurring, as indicated in the error screen 700 of FIG. 10 or the jam screen 800 of FIG. 12, and can confirm whether temperature changes are a factor in errors or jams.

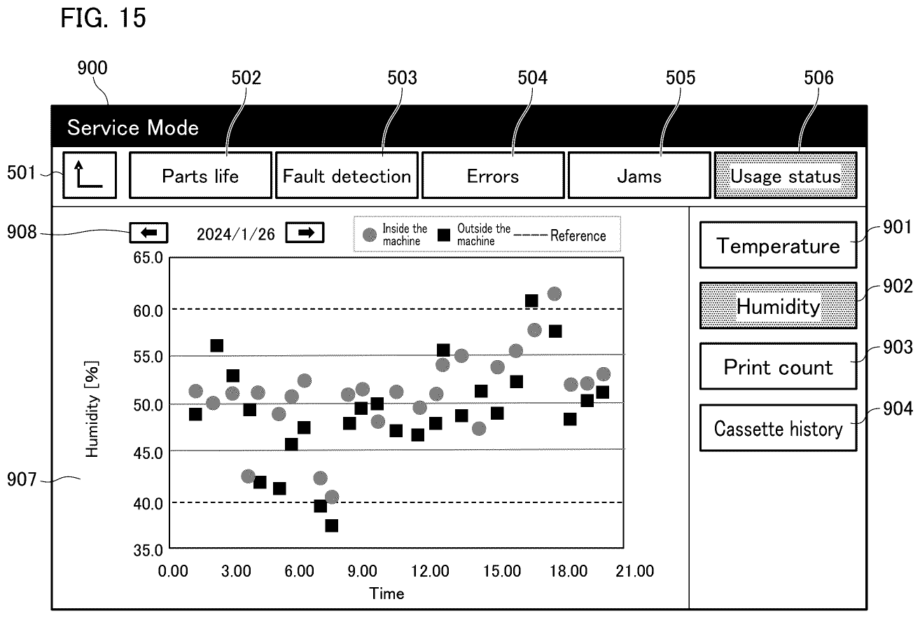

FIG. 15 is a diagram showing a humidity change screen that is displayed by the humidity button 902 of the usage status screen 900 being pressed. A humidity change graph 907 represents humidity (%) on the vertical axis and time on the horizontal axis and shows one day of humidity inside the machine/outside the machine at 10-minute intervals. A date switching button 908 is a button for switching the date of the displayed graph and enables display of data up to one month prior.

In the humidity change graph 907, as a reference range for humidity, the upper limit and the lower limit are displayed as broken lines, and, in a case in which humidity outside the reference range is shown, a determination can be made that review of the environment is necessary. In addition, service personnel can compare a period of the humidity change screen of FIG. 15 that is identical to a period in which a jam is occurring in the jam screen 800 of FIG. 12, and can confirm whether humidity changes are a factor in jams.

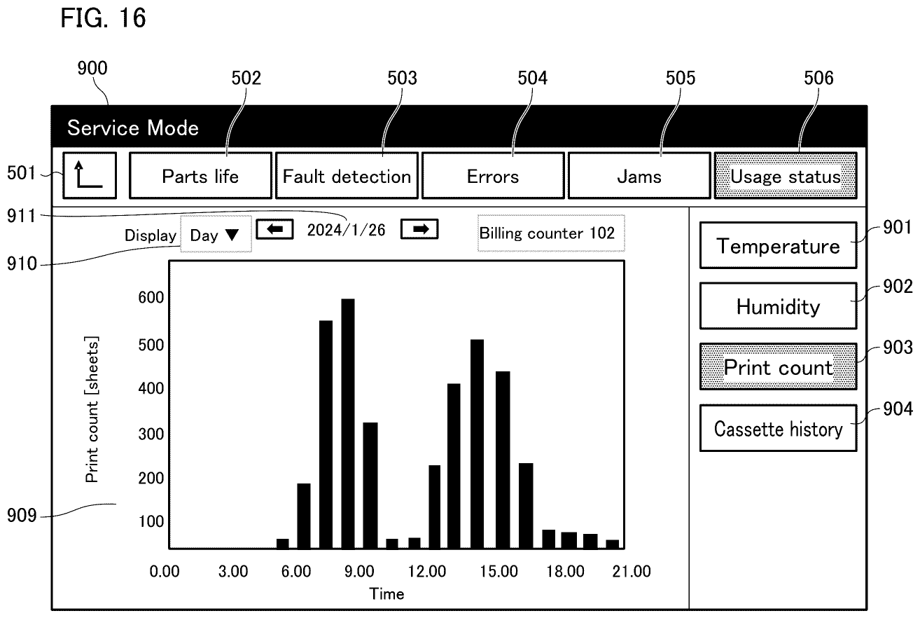

FIG. 16 is a diagram showing a print count screen that is displayed by pressing the print count button 903 of the usage status screen 900. A print count graph 909 represents print count (sheets) on the vertical axis and time on the horizontal axis.

A display period switching button 910 is a button for performing a change of the display period of the graph to units of one month or one day. A date switching button 911 is a button for switching the date of display of the graph. In a case in which “month” is selected by the display period switching button 910, data for one month at one-day intervals are displayed, and, by a selection using the date switching button 911, data for each month are displayed by being switched. In addition, in this case, year and month are displayed on the date switching button 911, and the horizontal axis of the print count graph 909 is displayed in units of days (rather than “time” (time of day) as shown in the example of FIG. 16).

In contrast, in a case in which “day” is selected by the display period switching button 910, as shown in the example of FIG. 16, data for one day are displayed at one-hour intervals, and, by a selection using a date switching button, data for each day are displayed by being switched. In this case, year, month, and day are displayed on the date switching button 911, and the horizontal axis of the print count graph 909 is displayed in units of time (time of day).

For example, in a case in which it is estimated from the parts life screen 500 of FIG. 6 that a part reaches a usage limit earlier than scheduled, the following estimation becomes possible. That is, in a case in which service personnel confirm from the print count graph 909 of FIG. 16 that a large quantity is being printed immediately before the usage limit, service personnel can estimate that the large-quantity printing is possibly a cause of the above-described part reaching the usage limit earlier.

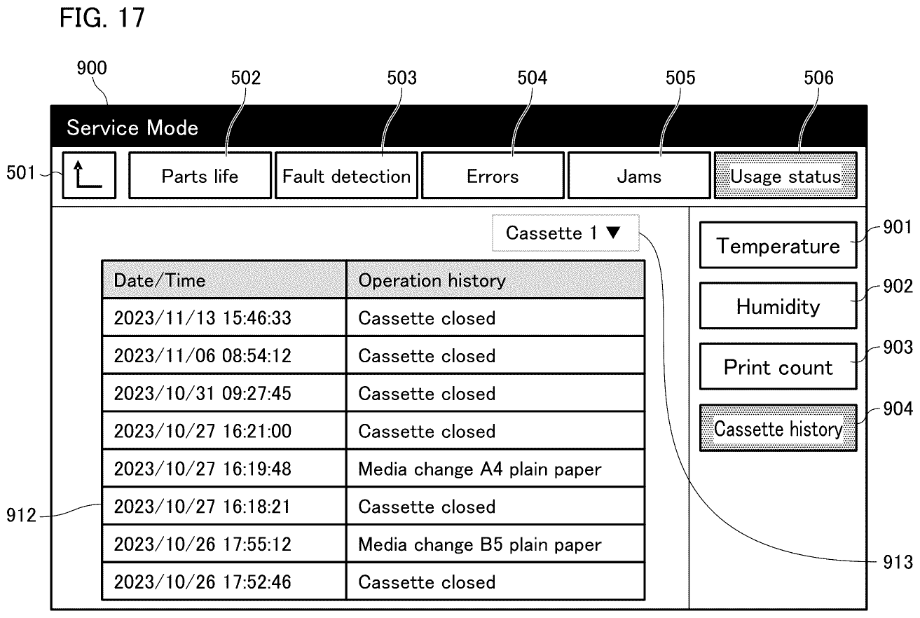

FIG. 17 is a diagram showing a cassette history screen that is displayed by the cassette history button 904 of the usage status screen 900 being pressed. A cassette history list 912 displays, in chronological order, a history of operations on a cassette. A cassette switching button 913 is a button for selecting a target cassette that is displayed in the cassette history list 912. For example, in a case in which jams or errors are occurring, service personnel can consider as follows by confirming a cassette history in the cassette history list 912. That is, service personnel can consider, by distinguishing between operations or setting mistakes by users that use the image processing apparatus and failures due to other factors, whether operations or setting mistakes by users that use the image processing apparatus are factors in the jams or errors or whether failures are due to other factors rather than operations or setting mistakes by users.

Hereinafter, in a case in which any one of the parts life button 502, the fault detection button 503, the errors button 504, and the jams button 505 is referred to without distinguishing among the buttons, the button may also be called a “state button.” The state button and the usage status button 506 are examples of a first operation region that accepts operations for switching display between the first information and the second information.

Display processing of any one of the parts list 507, the fault list 601, the error list 701, and the jam list 801 is an example of processing for displaying the first information in the information display region for each category by dividing the first information into a plurality of different categories. That is, the above-described first operation region includes a region that accepts selection of the category.

Display processing of any one of the temperature change graph 905, the humidity change graph 907, the print count graph 909, and the cassette history list 912 is an example of processing that causes the usage status to be displayed in the above-described information display region by dividing the usage status into a plurality of different categories and displaying the usage status for each category. That is, the temperature button 901, the humidity button 902, the print count button 903, and the cassette history button 904 are examples of a third operation region that accepts selection of the category.

### Configuration of History Data

Next, an explanation is provided with respect to data recorded in the history management unit 304 that manages data to be displayed on the above-described state monitor screen. The history management unit 304, via the device I/F 220 of FIG. 2, organizes values and settings acquired from the various sensors 255, the scanner 270, and/or the printer 295 into necessary information, and stores the information in the HDD 204 or the RAM 202.

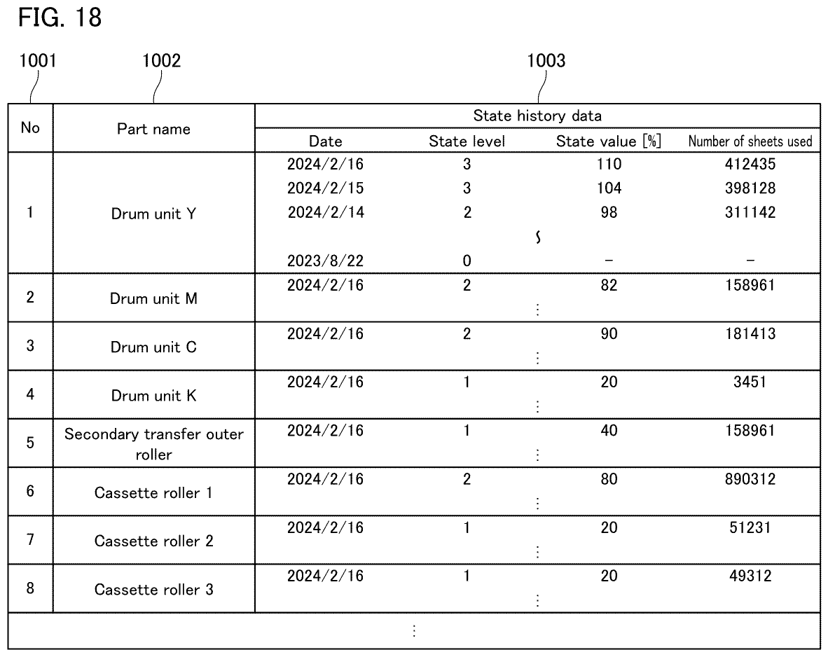

FIG. 18 shows history data used for displaying parts life information. The history data includes a number (No.) 1001, a part name 1002, and state history data 1003 of parts. The number 1001 indicates an arrangement order of parts in the history data. The state history data 1003 includes, for example, dates of data acquisition, state levels of parts, state values [%], and numbers of sheets used. The state history data 1003 is stored daily. The state level, the state value, and the number of sheets used are as explained above with reference to the parts list 507 of FIG. 6.

In the state history data 1003, parts having a state level “3” are displayed on the cross-sectional diagram 401 and in the parts life 403 of FIG. 4 as parts for which replacement is necessary. Parts having a state level “2” are displayed on the cross-sectional diagram 401 and in the parts life 403 of FIG. 4 as parts for which replacement is recommended. All parts indicated by the part name 1002 and the states of the parts are displayed in the parts list 507 of FIG. 6 in the arrangement order of the number 1001. In addition, the state history data 1003 is used for displaying the state transition graph 511 of FIG. 7. For example, because the display periods include 30 days and 180 days, at least 180 days of data is retained. In a case in which replacement of a part by service personnel is detected, the state level of the replaced part becomes “0”. A state level “0” means a state in which the value is undefined after replacement of the part. In addition, at that time, the state value [%] and the number of sheets used are not recorded. As described above, the parts life display of each screen is performed using the parts life history data of FIG. 18.

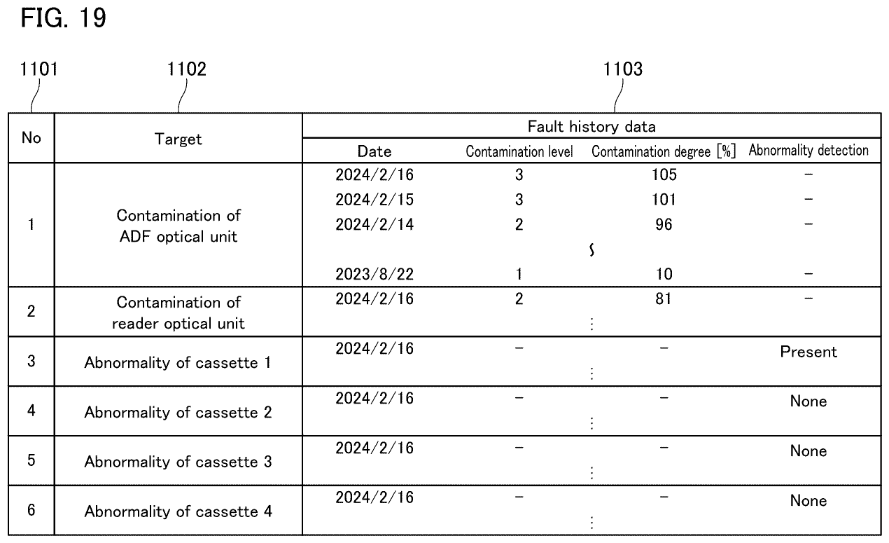

FIG. 19 shows history data used for displaying fault detection information. The history data includes a number (No.) 1101, a target 1102, and fault history data 1103. The number 1101 indicates the arrangement order of faults in the history data. The target 1102 indicates a fault name or fault content. The fault history data 1103 includes dates of data acquisition, contamination levels, contamination degrees [%], and cassette abnormality detection. The contamination level, the contamination degree [%], and the cassette abnormality detection are as explained above with reference to the fault list 601 of FIG. 8.

In the case of an optical unit, the history data includes dates of data acquisition, contamination levels, and contamination degrees [%], and this data is stored daily. For an optical unit having contamination level “3,” a fault for which checking is necessary is displayed in the cross-sectional diagram 401 and in the fault detection 404 of FIG. 4. For an optical unit having contamination level “2,” a fault for which checking is recommended is displayed in the cross-sectional diagram 401 and in the fault detection 404 of FIG. 4. In addition, the fault history data 1103 related to the optical unit is used for displaying the contamination transition graph 611 of FIG. 9. Because the display periods are 30 days and 180 days, at least 180 days of data is retained.

In the case of a cassette, the history data 1103 of each fault includes dates of data acquisition and presence or absence of abnormality detection, and this data is stored daily. Cassettes in which abnormality detection is “present” are displayed in the cross-sectional diagram 401 and in the fault detection 404 of FIG. 4 as faults for which checking is necessary. All target-1102 faults and states of the faults (contamination degree and contamination level) are displayed in the fault list 601 of FIG. 8 in the arrangement order of number 1101.

In a case in which, in FIG. 8, one target among the fault list 601 is selected by service personnel and the processed button 603 is pressed, a value related to the state of the target fault is updated as follows. That is, in a case in which the target fault is contamination of an optical unit, the contamination level value becomes level “0,” which is a state in which the value is undefined. At that time, the data of the contamination degree [%] is not present. In a case in which the target fault relates to a cassette, abnormality detection is updated to “none.” In this manner, the fault detection history data of FIG. 19 is used for the fault detection display of each screen.

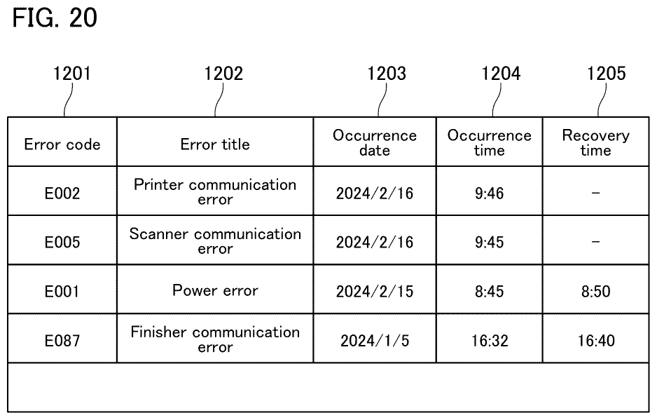

FIG. 20 shows history data used for displaying error information. The history data includes an error code 1201, an error title 1202, an occurrence date 1203, an occurrence time 1204, and a recovery time 1205. The error code 1201 is a code for identifying an error. The occurrence date 1203 is the date on which the error occurred, and the occurrence time 1204 is the time at which the error occurred. The recovery time 1205 is the time at which the error was resolved. Errors for which the recovery time 1205 is not recorded are displayed in the errors 405 of FIG. 4 as occurring errors.

The history data of FIG. 20 is displayed in the error list 701 of FIG. 10 in descending order of the occurrence date 1203 and the occurrence time 1204. Although not shown in FIG. 20, content corresponding to each error code 1201 is stored in the HDD 204 and is displayed in the error details screen of FIG. 11. As described above, the error history data of FIG. 20 is used for the error display of each screen.

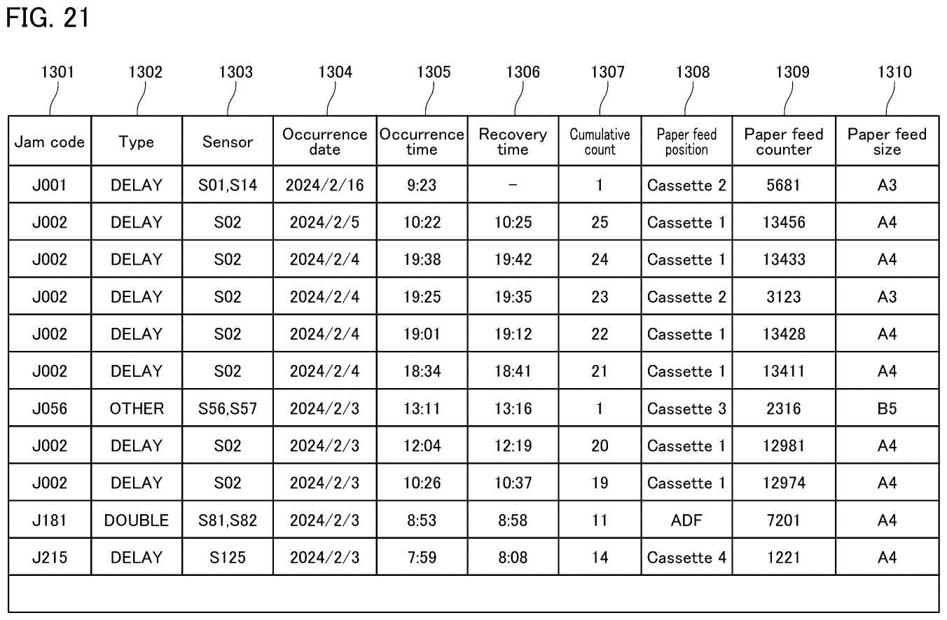

FIG. 21 shows history data used for displaying jam information. The history data includes a jam code 1301, a type 1302, a sensor 1303, an occurrence date 1304, an occurrence time 1305, a recovery time 1306, a cumulative count 1307, a paper feed position 1308, a paper feed counter 1309, and a paper feed size 1310.

The jam code 1301 is a code for identifying jams. The type 1302 is a jam type corresponding to the jam code. There are various types such as DELAY (delay), in which paper is not detected by a sensor even after an expected time has elapsed, STNRY (stationary), in which detection of paper by a sensor continues for longer than an expected time, and DOUBLE (double-feeding), in which an ADF sensor detects double-feeding of paper. The sensor 1303 is a sensor number that detected the jam. The occurrence date 1304 is the date on which the jam occurred, and the occurrence time 1305 is the time at which the jam occurred. The recovery time 1306 is the time at which the jam was resolved. Jams for which the recovery time 1306 is not recorded are displayed as currently occurring jams in the cross-sectional diagram 401 and in the jams 406 of FIG. 4.

The cumulative count 1307 is the number of occurrences of jams having the same jam code. The number of jams that have occurred after the reset date and time 804 of FIG. 12 is counted up as that cumulative count. For example, in a case in which the cumulative count has occurred a predetermined number of times (here 10 or more), a determination is made that the jam is a frequent jam, and the frequent jam is displayed in the cross-sectional diagram 401 and in the jams 406 of FIG. 4. The paper feed position 1308 is the position from which paper was supplied when the jam occurred. The paper feed counter 1309 is the number of sheets of paper supplied from the paper feed position.

The history data of FIG. 21 is displayed in the jam list 801 of FIG. 12 in descending order of the occurrence date 1304 and the occurrence time 1305. At that time, as described above, only the most recent instance of a jam having the same jam code is displayed. Histories of jams having the same jam code are displayed in the jam details screen of FIG. 13. It should be noted that, in a case in which the reset button 803 is pressed in FIG. 12, jam history prior to the date and time of pressing is deleted. In this manner, jam history data of FIG. 21 is used for the jam display of each screen.

It should be noted that each set of history data of FIG. 20 and FIG. 21 may also have sequential numbers such as number (No.) 1001 and number (No.) 1101 shown in history data of FIG. 18 and FIG. 19.

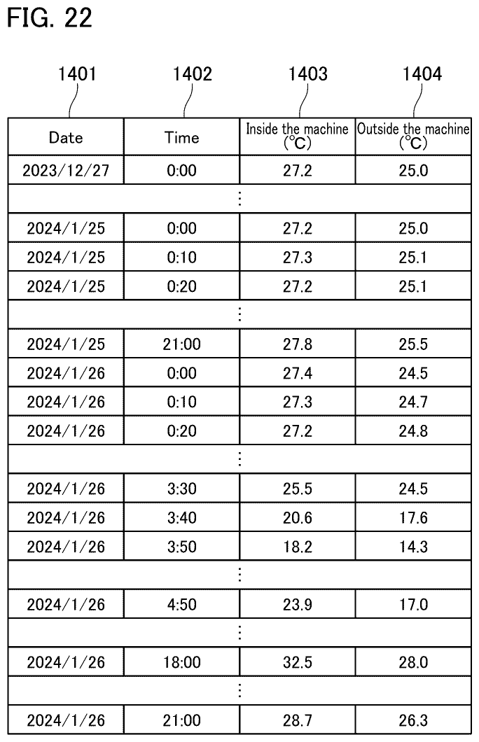

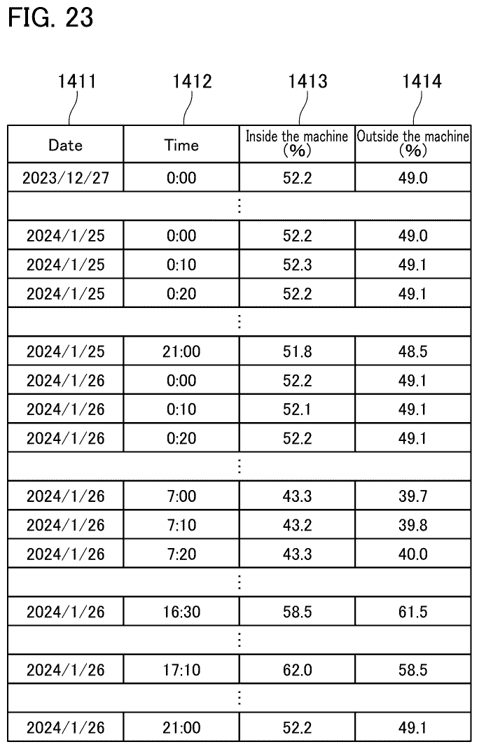

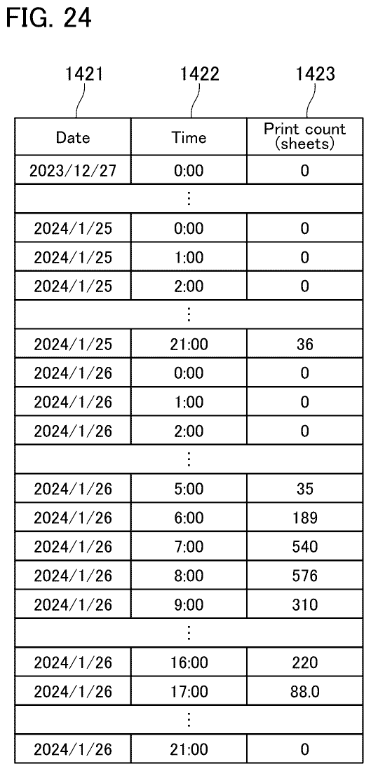

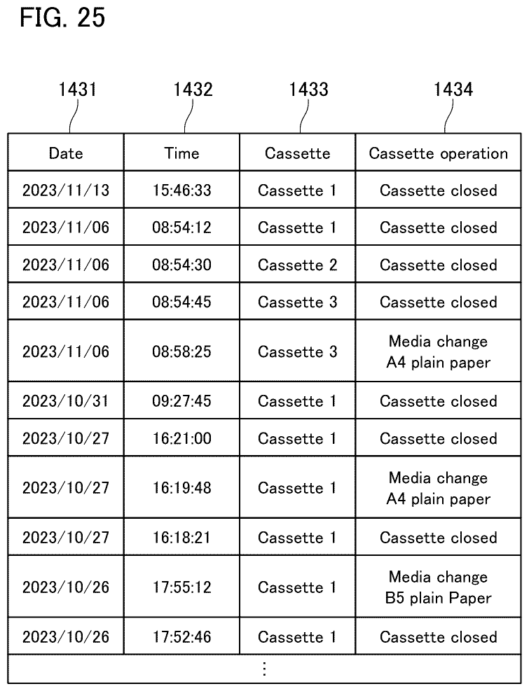

FIG. 22 shows data used for displaying information of usage status (temperature), FIG. 23 shows data used for displaying information of usage status (humidity), FIG. 24 shows data used for displaying information of usage status (print count), and FIG. 25 shows data used for displaying information of usage status (cassette history).

FIG. 22 shows temperature data used for displaying information of temperature change. The data includes date 1401, time 1402, inside the machine 1403, and outside the machine 1404. The date 1401 indicates a date on which temperature data is acquired, and, for example, data for one month is stored. The time 1402 indicates a time at which temperature data is acquired, and, for example, data is stored at 10-minute intervals. For inside the machine 1403, temperature data acquired by a thermometer installed inside the machine (not shown) is stored. For outside the machine 1404, temperature data acquired by a thermometer installed outside the machine (not shown) is stored. The above data shown in FIG. 22 is used for the display of the temperature change graph 905 of FIG. 14.

FIG. 23 shows humidity data used for displaying information of humidity change. The data includes date 1411, time 1412, inside the machine 1413, and outside the machine 1414. The date 1411 indicates a date on which humidity data is acquired, and, for example, data for one month is stored. The time 1412 indicates a time at which humidity data is acquired, and, for example, data is stored at 10-minute intervals. For inside the machine 1413, humidity data acquired by a hygrometer installed inside the machine (not shown) is stored. For outside the machine 1414, humidity data acquired by a hygrometer installed outside the machine (not shown) is stored. The above data shown in FIG. 23 is used for the display of the humidity change graph 907 of FIG. 15.

FIG. 24 shows print count data used for displaying information of print count. The data includes date 1421, time 1422, and print count 1423. The date 1421 indicates a date on which print count data is acquired. The time 1422 indicates a time at which print count data is acquired. The print count 1423 indicates a number of sheets printed by the image processing apparatus 103. For example, for one month, data for date 1421, time 1422, and print count 1423 is stored at one-hour intervals. The above data shown in FIG. 24 is used for the display of the print count graph 909 of FIG. 16.

FIG. 25 shows cassette operation data used for displaying cassette history information. This data is data that is stored when a user performs, with respect to a cassette of the image processing apparatus 103, a closing operation or an operation to change media (that is, paper). This data includes date 1431, time 1432, cassette 1433, and cassette operation 1434. The date 1431 indicates a date on which the cassette operation was performed. The time 1432 indicates a time at which the cassette operation was performed. The cassette 1433 indicates information on a location of the cassette that was operated. The cassette operation 1434 stores “cassette closed” when a closing operation is performed on a cassette. In addition, when an operation to change media is performed, “media change” and the paper size and paper type after the change are stored. For the cassette history information, data is stored in a predetermined number of entries (for example, up to 300 entries). The above data shown in FIG. 25 is used for the display of the cassette history list 912 of FIG. 17.

It should be noted that, with respect to the cassette operation data, storage is not limited to a cassette, and manual feed operation data may also be stored.

### Processing That the Image Processing Apparatus Executes

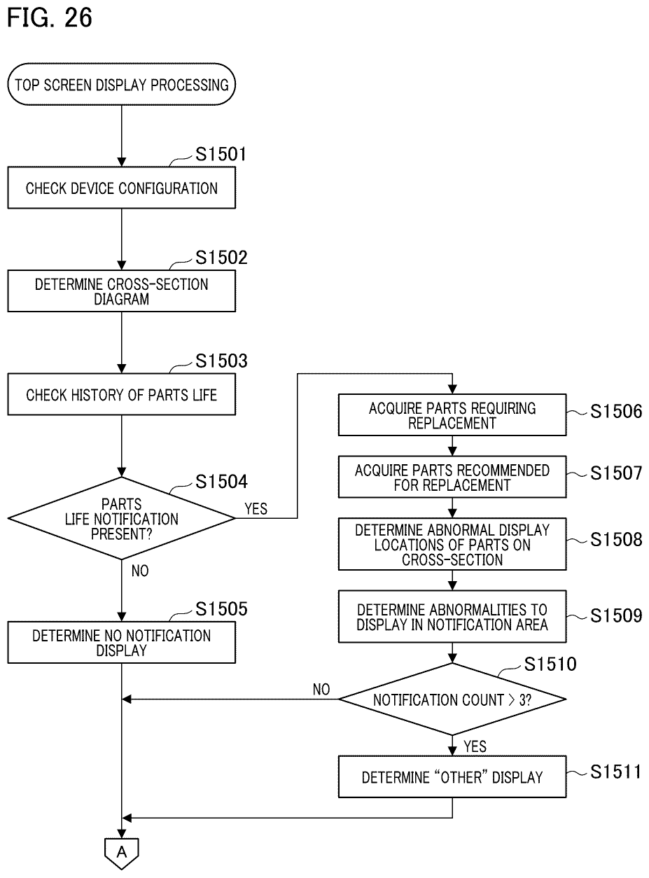

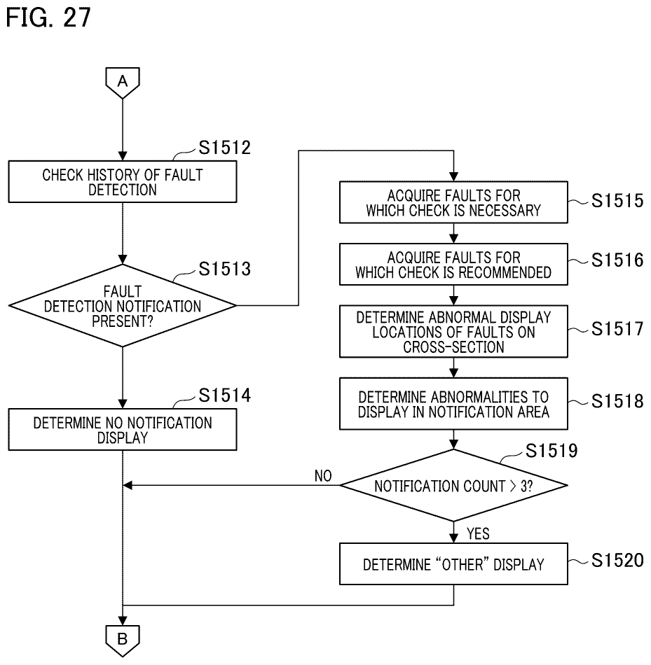

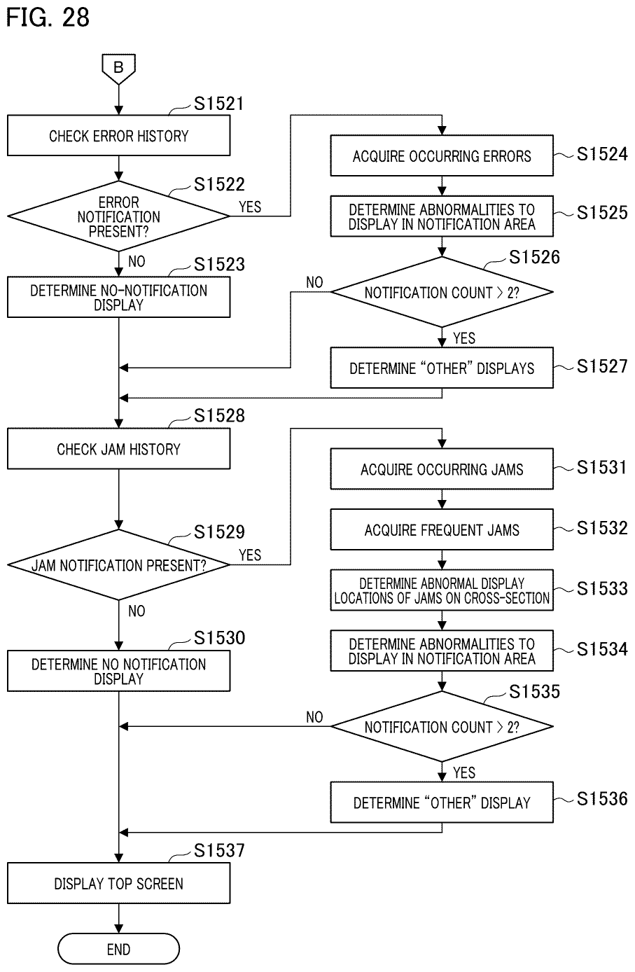

FIGS. 26 to 28 are flowcharts showing examples of display processing of the top screen (FIG. 4) that includes activation processing of a state monitor. A program (for example, firmware) for realizing the processing is stored in the HDD 204 of the image processing apparatus 103, and is loaded into the RAM 202 and executed by the CPU 201.

The processing is started on the basis that input of a special command for activating the state monitor has been accepted by the CPU 201 via the operation unit 212 from service personnel.

In step S1501, the CPU 201 refers to the apparatus configuration information (not shown) of the image processing apparatus stored in the RAM 202.

In step S1502, the CPU 201 determines a cross-sectional diagram to be displayed in each screen. For example, the cross-sectional diagram to be displayed changes according to the presence or absence of a scanner, the presence or absence of a paper feed option, and presence or absence of a paper discharge option. In a case in which a common program operates between a plurality of image processing apparatuses, the CPU 201 may switch to a cross-sectional diagram suitable for the model according to model information. This is because positions of paper transport paths, parts, and jam sensors may differ depending on the model of the image processing apparatus.

In step S1503, the CPU 201 refers to the history data of parts life shown in FIG. 18 that is stored in the HDD 204.

In step S1504, the CPU 201 determines, based on the result of the reference in step S1503, whether there is a part for which the state level is “2” or higher.

In a case in which the determination result of step S1504 is NO, in step S1505, the CPU 201 determines that there is no icon of parts life to be displayed in the cross-sectional diagram 401 of FIG. 4, and determines that “No notifications” is to be displayed in the notification area of parts life 403. In a case in which the determination result is YES, in step S1506, the CPU 201 acquires information of parts for which replacement is necessary having a state level of “3” from the history data of parts life.

In step S1507, the CPU 201 acquires information of parts for which replacement is recommended having a state level of “2” from the history data of parts life. The order of step S1506 and step S1507 may be reversed.

In step S1508, the CPU 201 displays, at the corresponding coordinates on the cross-sectional diagram 401, icons indicating that replacement is necessary and/or that replacement is recommended for the parts for which notification is necessary that were acquired in step S1506 and step S1507.

In step S1509, the CPU 201 displays the parts for which notification is necessary that were acquired in step S1506 and step S1507 in order from higher priority. As the priority, replacement necessary (state level “3”) is set higher than replacement recommended (state level “2”). In a case in which the levels are the same, display is in the order of the number (No.) 1001 of FIG. 18.

In step S1510, the CPU 201 determines whether the number of parts that should be notified is greater than the number of parts that are displayable in the notification area of parts life 403 (for example, three). In a case in which the determination result is NO, processing proceeds to step S1512. In a case in which the determination result is YES, in step S1511, the CPU 201 displays, by a character string “Other:” and by a number of entries, the notifications that cannot be fully displayed.

In step S1512, the CPU 201 refers to the history data of fault detection shown in FIG. 19 that is stored in the HDD 204.

In step S1513, the CPU 201 determines whether faults of optical units having a contamination level “2” or higher and/or cassettes having an abnormality exist based on the result of the reference in step S1512.

In a case in which the determination result is NO, in step S1514, the CPU 201 determines that there are no icons of fault detection to be displayed on the cross-sectional diagram 401 of FIG. 4, and determines that “No notifications” is to be displayed in the notification area of fault detection 404. In a case in which the determination result is YES, in step S1515, the CPU 201 acquires information of optical units having a contamination level “3” and/or cassettes having an abnormality from the history data of fault detection.

In step S1516, the CPU 201 acquires information of optical units having a contamination level “2” from the history data of fault detection. The order of step S1515 and step S1516 may be reversed.

In step S1517, the CPU 201 displays, at the corresponding coordinates on the cross-sectional diagram 401, icons of check necessary and/or check recommended for the faults for which notification is necessary that were acquired in step S1515 and step S1516.

In step S1518, the CPU 201 displays, in order from higher priority, the faults for which notification is necessary that were acquired in step S1515 and step S1516. As a priority, check necessary (contamination level “3”) is set higher than check recommended (contamination level “2”), and in a case in which the levels are the same, display is in the order of the number (No.) 1101 of FIG. 19.

In step S1519, the CPU 201 determines whether the number of faults that should be notified is greater than the number of faults that are displayable in the notification area of the fault detection 404 (for example, three). In a case in which the determination result is NO, processing proceeds to step S1521. In a case in which the determination result is YES, in step S1520, the CPU 201 displays, by a character string “Other:” and by a number of entries, the notifications that cannot be fully displayed.

In step S1521, the CPU 201 refers to history data of errors shown in FIG. 20 that is stored in the HDD 204.

In step S1522, the CPU 201 determines, based on the results of the reference in step S1521, whether there is an error that is currently occurring in which the recovery time 1205 of FIG. 20 is not registered.

In a case in which the determination result is NO, in step S1523, the CPU 201 determines that “No notifications” is to be displayed in the notification area of the errors 405. In a case in which the determination result is YES, in step S1524, the CPU 201 acquires, from the history data of errors, information of errors that are currently occurring in which the recovery time 1205 is not registered.

In step S1525, the CPU 201 displays, in descending order of acquisition, the errors for which notification is necessary that were acquired in step S1524.

In step S1526, the CPU 201 determines whether the number of errors to be notified is greater than the number of errors that are displayable in the notification area of the errors 405 (for example, two). In a case in which the determination result is NO, processing proceeds to step S1528. In a case in which the determination result is YES, in step S1527, the CPU 201 displays the notifications that cannot be fully displayed by the character string “Other:” and by the number of entries.

In step S1528, the CPU 201 refers to the history data of jams shown in FIG. 21 that is stored in the HDD 204.

In step S1529, the CPU 201 determines, based on the results of the reference in step S1528, whether there is a jam that is currently occurring in which the recovery time 1306 of FIG. 21 is not registered, or whether there is a frequently occurring jam in which the cumulative count 1307 is 10 or more.

In a case in which the determination result is NO, in step S1530, the CPU 201 determines that no jam icons are to be displayed on the cross-sectional diagram 401 of FIG. 4, and that “No notifications” is to be displayed in the notification area of the jams 406. In a case in which the determination result is YES, in step S1531, the CPU 201 acquires information of jams that are currently occurring in which the recovery time 1306 is not registered from the jam history data.

In step S1532, the CPU 201 acquires information of frequently occurring jams in which the cumulative count 1307 is 10 or more from the history data of jams. The order of step S1531 and step S1532 may be reversed. It should be noted that, among the history data of jams of FIG. 21, in a case in which a plurality of entries having the same jam code are registered, the information of the most recent single entry is acquired.

In step S1533, the CPU 201 displays, at the corresponding coordinates on the cross-sectional diagram 401, icons of jams for which notification is necessary that are currently occurring and/or frequently occurring that were acquired in steps S1531 and S1532.

In step S1534, the CPU 201 displays the jams for which notification is necessary in order of higher priority that were acquired in steps S1531 and S1532. As the priority, a currently occurring jam is set higher than a frequently occurring jam. In a case in which the levels are the same, for example, display is in descending order of acquisition. In addition, in a case in which a jam corresponds to both currently occurring and frequently occurring, the information of the currently occurring jam is displayed by prioritizing the currently occurring jam.

In step S1535, the CPU 201 determines whether the number of jams for which notification is necessary is greater than the number of jams that are displayable in the notification area of the jams 406 (for example, two). If the determination result is NO, processing proceeds to step S1537. If the determination result is YES, in step S1536, the CPU 201 displays the notifications that cannot be fully displayed by the character string “Other:” and by the number of entries.

In step S1537, the CPU 201 displays, on the screen of the operation unit 212, the display content determined in steps S1501 to S1536. That is, the CPU 201 displays the top screen 400 of the state monitor of FIG. 4.

By the processing of FIGS. 26 to 28, abnormalities of the image processing apparatus 103 and occurrence locations thereof that service personnel on site want to confirm quickly can be displayed on the cross-sectional diagram 401 and in the notification areas (403 to 406). Accordingly, service personnel can know, on one screen of the top screen 400, the entirety of the abnormalities of the image processing apparatus and occurrence locations thereof. As a result, the efficiency of the work for confirming abnormality locations is improved for service personnel who are required to respond quickly on site. Furthermore, from the cross-sectional diagram 401, service personnel can identify locations at which two or more abnormalities are concentrated, and can also think of efficient work procedures thereafter, such as to perform work collectively on the concentrated abnormalities.

As described above, according to the present embodiment, in particular, the abnormality information occurring in the apparatus and occurrence locations thereof, as information necessary for maintenance work of the image processing apparatus 103, can be efficiently displayed within a limited screen region, and the work efficiency of service personnel is improved.

In addition, service personnel can also estimate correlation of the occurrences of those abnormalities from positional relationships of occurrence locations of a plurality of abnormalities in the cross-sectional diagram 401. For example, in a case in which a notification of replacement necessity of cassette roller 1 and a notification of frequently occurring jams in the vicinity of cassette roller 1 are acquired at the same time, in a temporally proximate time range, or in a temporally proximate period, it can be understood that there is a high possibility that the frequently occurring jams will be resolved by replacing cassette roller 1.

### Second Embodiment

Hereinafter, a Second Embodiment will be explained. In the Second Embodiment, explanation of components and processing similar to those of the First Embodiment described above is omitted.

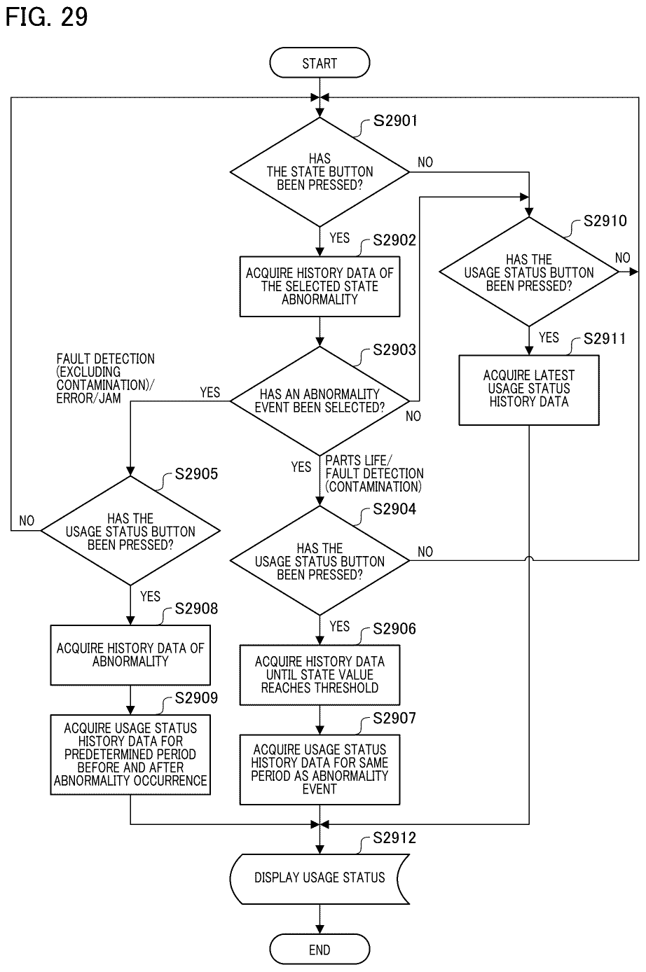

FIG. 29 is a flowchart showing an example of display processing of a usage status screen 900 according to operations of the operation unit 212 by service personnel after display of the top screen 400 in the present embodiment. In performing maintenance work, service personnel first confirm state abnormality information, that is, information of parts life, fault detection, errors, and jams, and next confirm usage status information together with the state abnormality information for analysis of causes of abnormalities among those states. At that time, it is desirable to enable the state abnormality information and the usage status information to be confirmed in association with each other. Accordingly, in the present embodiment, in a case in which service personnel select abnormality information that is a target of cause analysis from state history data and open the usage status screen 900, an example in which the selected abnormality information and the usage status data are displayed together in the usage status screen 900 is explained.

According to the selected abnormality information, the display unit 302 changes the display range of the time series of the usage status and appropriately displays information necessary for cause analysis. For example, history data of parts life is data representing transition until reaching the usage limit of a part, and by displaying usage status data for the same period as the period during which the state is transitioning, service personnel can identify environmental information attributable to parts life. In addition, for example, jam history data is data indicating the jam occurrence timing and jam content, and by displaying usage status data for a certain period before and after the jam occurrence timing, service personnel can effectively perform cause analysis of jams.

In step S2901, the CPU 201 determines whether a state button is pressed in FIGS. 6, 8, 10, 12, and 14 to 17. In a case in which a state button is pressed, in step S2902, the CPU 201 acquires history data of abnormalities of the selected state, and displays a screen according to the selection, that is, any one of screens 500, 600, 700, and 800.

In step S2903, the CPU 201 determines whether one abnormality event of the displayed lists is selected. The displayed list is any one of the parts list 507, the fault list 601, the error list 701, or the jam list 801. A region that displays any one of the lists 507, 601, 701, or 801 is an example of a second operation region. It should be noted that, in a case in which one abnormality event of the list is selected, the display unit 302 performs emphasis processing with respect to the selected abnormality event. This applies similarly to the First Embodiment described above.

In a case in which an abnormality event is selected in step S2903 and the selected category is a category related to contamination among fault detection or is parts life, processing proceeds to step S2904. In addition, in a case in which an abnormality event is selected in step S2903 and the selected category is a category other than a category related to contamination among fault detection, or is a category of error, or is a category of jam, processing proceeds to step S2905. In steps S2904 and S2905, the CPU 201 determines whether the usage status button 506 is pressed.

In a case in which the usage status button is pressed in step S2904, in step S2906, the CPU 201 acquires history data of abnormalities such as parts life or fault detection (contamination) from the HDD 204. Specifically, the CPU 201 acquires history data until those state values reach a threshold. With respect to parts life and fault detection (contamination), replacement of a part is necessary when the state value reaches 100%. Therefore, the CPU 201 acquires history data of the relevant event until the state value reaches 100%. For example, in a case in which “drum unit Y” is selected in the parts list 507, the CPU 201 acquires history data related to drum unit Y among the history data of parts life of FIG. 18. That is, the acquired data is number 1001, part name 1002, and part state history data 1003 related to drum unit Y. At this time, among the history data 1003, data for the period from 2024 Feb. 14 to 2024 Aug. 22, before the state value reaches 100%, is acquired.

After step S2906, in step S2907, the CPU 201 acquires history data of usage status stored in the HDD 204. At that time, the CPU 201 acquires history data of usage status for the same period as history data of the event acquired in step S2906. For example, in a case in which the CPU 201 displays the temperature change screen of the usage status (in a case in which the temperature button 901 is pressed), the CPU 201 acquires the temperature data of FIG. 22. In a case in which history data related to drum unit Y is acquired in step S2906, the period of the history data of drum unit Y is from 2023 Aug. 22 to 2024 Feb. 14 according to FIG. 18, and the history data of the temperature data for the same period is also acquired.

After step S2907, in step S2912, the CPU 201 uses the history data acquired in step S2906 and the history data of usage status acquired in step S2907 to create a graph or a list, and displays the usage status screen on the operation unit 212.

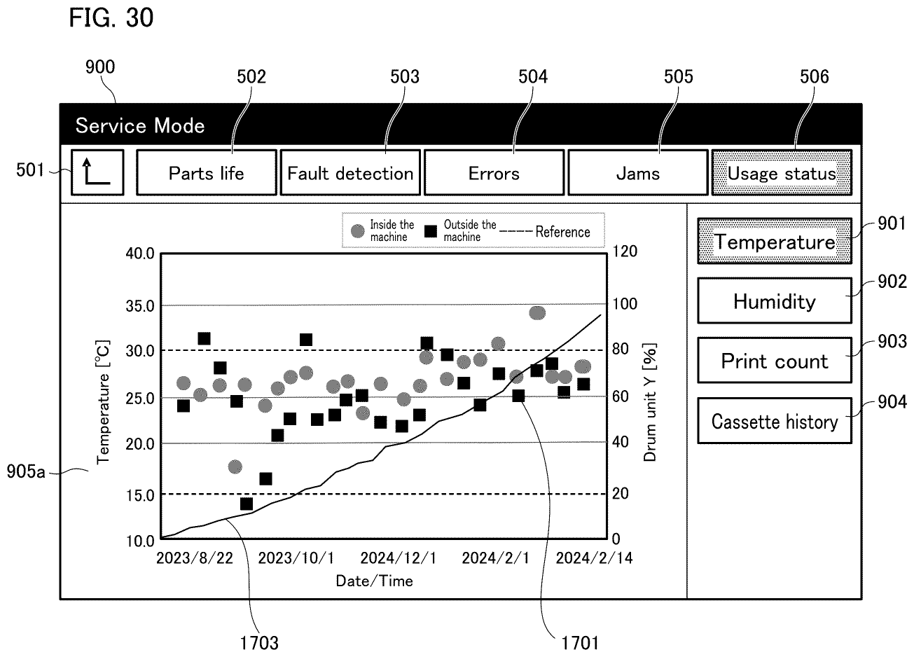

FIG. 30 shows an example of the usage status screen 900 that is displayed in step S2912 via processing of steps S2906 and S2907. This usage status screen 900 includes a graph 905a including respective history data of temperature changes and drum unit Y. In the graph 905a, respective history data of drum unit Y and temperature changes is displayed overlapped in one graph. In other words, the two sets of history data are displayed on a single time series within the information display region.

The range of date and time of the horizontal axis shows the period 2023 Aug. 22 to 2024 Feb. 14 of the history data of drum unit Y acquired in step S2906. In the graph 905a, history data 1703 of drum unit Y is represented as a change in the state value (referenced by the vertical axis on the right side). The history data 1703 of drum unit Y shows a transition of the state value of less than 100% for the period 2023 Aug. 22 to 2024 Feb. 14. History data 1701 of temperature changes is represented as a plurality of plots. The information of the change of the state value, which is the history data 1703, is an example of third information that shows the first information in a time series.

As shown in FIG. 30, in the present embodiment, the CPU 201 causes the display period of the history data of the usage status to coincide with the display period of the history data of the state abnormality in the usage status screen 900. More generally, the CPU 201 controls the display period of the history data of the usage status in accordance with the display period of the history data of the state abnormality.

Service personnel can simultaneously confirm the history data of the usage status until reaching the thresholds of parts life and fault detection (contamination) by viewing the graph of FIG. 30. Therefore, service personnel can grasp trends of the timing of parts replacement and the timing of contamination cleaning from the relationship with the usage status. Accordingly, service personnel become able to easily estimate the causes of faults, and subsequent maintenance work can be performed efficiently without waste.

In a case in which the usage status button is pressed in step S2905, in step S2908, the CPU 201 acquires history data of abnormalities such as fault detection (other than contamination), errors, or jams from the HDD 204. For example, in a case in which a jam is selected, the CPU 201 acquires the history data of jams of FIG. 21. In a case in which service personnel select the jam having the occurrence date and time “2024 Feb. 16 10:32—” in the jam list 801, the CPU 201 refers to the occurrence date 1304 and the occurrence time 1305 in FIG. 21, and acquires the history data of the jam corresponding to the selected jam.

In step S2909, the CPU 201 acquires history data of the usage status stored in the HDD 204. At that time, the CPU 201 acquires history data of the usage status for a certain period before and after the occurrence date and time of the history data acquired in step S2908. For example, in a case in which the CPU 201 displays cassette history of the usage status (in a case in which the cassette history button 904 is pressed), the CPU 201 acquires cassette history data for a certain period before and after the occurrence date and time of the selected jam event from the cassette history data of FIG. 25. In this example, the occurrence date and time of the selected jam event is “2024 Feb. 16 10:32—”.

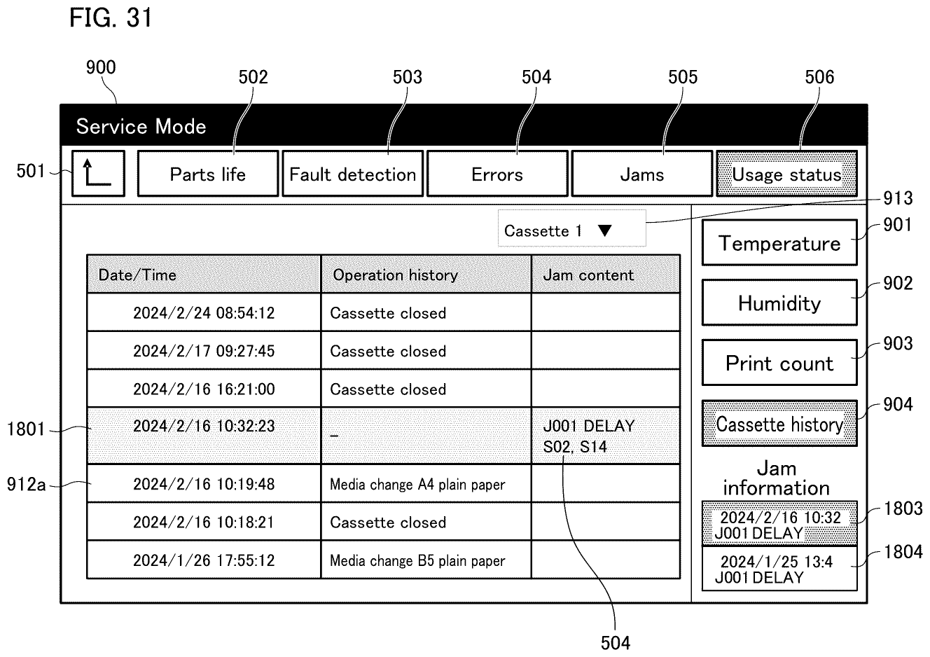

After step S2909, in step S2912, the CPU 201 uses the abnormality history data acquired in step S2908 and the usage status history data acquired in step S2909 to create a graph or list, and displays a usage status screen on the operation unit 212. An example of the usage status screen that is displayed here is explained in FIG. 31.

FIG. 31 is a diagram showing an example of the usage status screen 900 displayed in step S2912 via processing of steps S2908 and S2909. The usage status screen 900 includes a list 912a that includes the respective history data of cassettes and jams. That is, in the list 912a, the cassette history list and the history data of jams are displayed in one list. In other words, the two sets of history data are displayed on a single time series within the information display region. In this example, the history data 1801 of the jam acquired in step S2908 is displayed so as to be inserted as a single row within the cassette history list.

The history data 1801 of jams includes date and time and jam content. In the list 912a, history data is arranged in chronological order. The jam content includes at least part of the history data of jams shown in FIG. 21 corresponding to the displayed date and time. In the example of FIG. 31, jam code 1301, type 1302, sensor 1303, and the like are displayed. The CPU 201 may display the jam details screen 810 (FIG. 13) by service personnel selecting a row of the history data 1801 of jams and selecting the details button (not shown). In the list 912a, the CPU 201 displays the history data of cassettes acquired in step S2909 before and after the data corresponding to the history data 1801 of jams.

Jam information 1803 displayed at the lower right of the screen is currently selected jam information, and is display information corresponding to the history data 1801. In addition, other jam information 1804 is displayed adjacent to the display region of the jam information 1803. The jam information 1804 indicates that jams of the same type as the jam type “DELAY” of the jam information 1803 are present. In this manner, in a case in which a plurality of events of the same type are occurring, the CPU 201 can display information of the plurality of events of the same type together as related information within one usage status screen 900. Here, in a case in which service personnel select the jam information 1804, the CPU 201 may redisplay, within the information display region of the usage status screen 900, a list including the history data of a jam (not shown) corresponding to the jam information 1804 and the history data of cassettes for a certain period before and after that. By this, service personnel can confirm a plurality of pieces of jam information of the same type in association with time series information of cassette history, and can grasp trends of jam occurrence in relationship with cassette history. The display regions of the jam information 1803 and the jam information 1804 are examples of regions that accept selection of abnormality information of one abnormality from among abnormality information of a plurality of abnormalities.

As described above, service personnel can determine whether jams are occurring due to paper setting errors by users by confirming the list of FIG. 31.

Processing after a NO determination in step S2901 is similar to processing of the First Embodiment described above. Specifically, in a case in which a state button is not pressed in step S2901 and the usage status button 506 is pressed in step S2910, the CPU 201 performs the following processing. That is, in step S2911, the CPU 201 acquires history data of usage status for a certain period from the latest data stored in the HDD 204. In step S2912, the CPU 201 uses the acquired history data of usage status to create a graph or list, and displays the usage status screens of FIG. 14 to FIG. 17 on the operation unit 212.

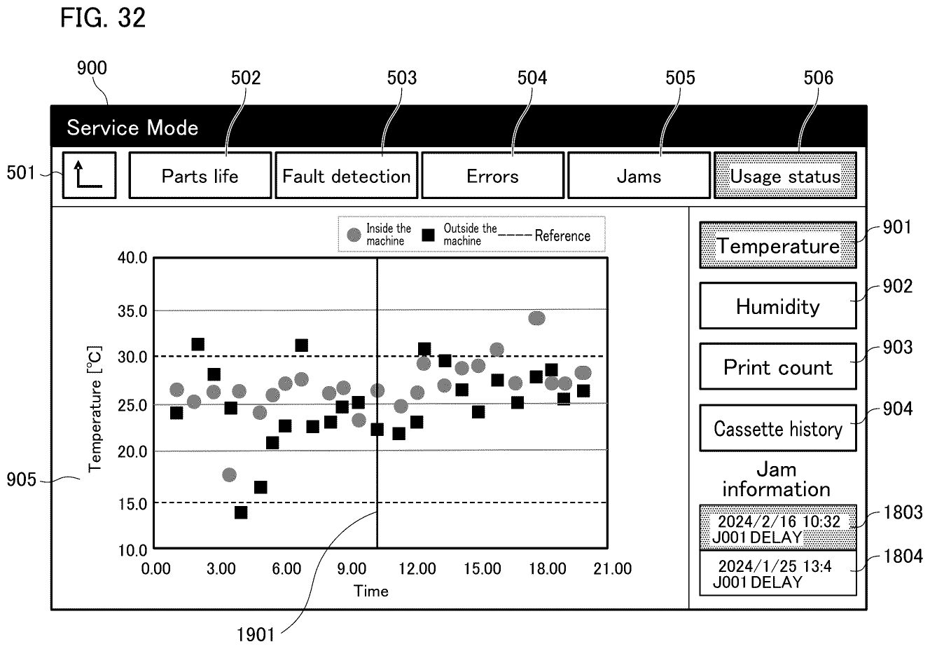

FIG. 32 shows an example of the usage status screen 900 displayed in another processing of steps S2908, S2909, and S2912. In FIG. 31, an example was explained in which cassette information for a certain period before and after jam occurrence timing in selected history data is displayed. The usage status screen 900 of FIG. 32 is displayed, for example, when the temperature button 901 is selected from a state in which the screen of FIG. 31 is displayed. At that time, the CPU 201 displays usage status of temperature while carrying over the selected jam information 1803 of FIG. 31. The usage status screen 900 includes a temperature change graph 905. The temperature change graph 905 includes history data of temperature changes for a certain period before and after jam occurrence timing 1901.

Service personnel can determine whether jams are occurring due to environmental factors by confirming the usage status screen 900 of FIG. 32. In addition, service personnel can easily switch between the usage status screen 900 of FIG. 31 and the usage status screen 900 of FIG. 32 by operations of the temperature button 901 and the cassette history button 904, and this assists in identifying causes of the occurrence of jams.

In FIG. 30 to FIG. 32, examples of displaying parts life, jams, temperature, and cassette history as history data were explained. However, as history data, fault detection may be displayed instead of parts life or jams, or errors may be displayed. In addition, as history data, humidity may be displayed instead of temperature or cassette history, or print count may be displayed.

As described above, according to processing of FIG. 29, an example was explained of displaying history data of any one abnormality among parts life, fault detection, errors, and jams in association with history data of usage status of temperature, humidity, number of prints, and cassettes. The present embodiment switches the display period of usage status in accordance with selection of abnormality events by service personnel, and can appropriately display usage status information related to the abnormality events. In this manner, service personnel can easily perform analysis of abnormalities occurring in the image processing apparatus 103 when performing maintenance work.

### Other Embodiments

In a case in which the display period is changed in any of the detail screens of FIG. 7, FIG. 9, and FIG. 14 to FIG. 17, the CPU 201 may also switch the display by linking the display period of another detail screen. For example, the usage status screen 900 including the humidity change graph 907 of FIG. 15 is displayed, and service personnel change the date to “2024 Jan. 25” using the date switching button 908. Service personnel then select the temperature button 901, and it is assumed that the usage status screen 900 including the temperature change graph 905 of FIG. 14 is displayed. At this time, the date switching button 906 of the temperature change graph 905 also automatically switches to “2024 Jan. 25”, and the temperature change graph 905 of “2024 Jan. 25” is displayed. Furthermore, in a case in which service personnel then select the errors button 504, errors that occurred on “2024 Jan. 25” are displayed in the error screen 700 (FIG. 10). In a case in which no error occurrence exists on “2024 Jan. 25”, errors of neighboring dates may be displayed. In this manner, service personnel can confirm detailed information of each event and each usage status displayed in a time series by associating each event and each usage status with one another.

In addition, in FIG. 29 to FIG. 31, an example was explained in which the display period of one piece of history data among categories of usage status is switched according to selection of one event among one category of state abnormalities. As another example, there may be cases in which one event among one category of state abnormalities and one piece of history data among categories of usage status have low correlation, or have no correlation. In a case in which the combination has low correlation, or has no correlation, the CPU 201 may perform processing of steps S2911 and S2912, and may display only history data of usage status. For example, in a case in which the CPU 201 determines that transitions of parts life and cassette history data have low correlation, the CPU 201 may display only cassette history data. Similarly, the CPU 201 may switch the display according to correlation degree of combinations of other events and usage status.

In addition, for example, the usage status screen 900 may include regions that accept operations to switch between graph format display (for example, FIG. 30) and list format display (for example, FIG. 31) of history data. For example, the CPU 201 displays abnormality history data in graph format, and in a case in which service personnel want to confirm part of the history data in detail, the CPU 201 can switch to list format display in response to an operation to switch the display format.

Embodiment(s) of the present disclosure can also be realized by a computer of a system or apparatus that reads out and executes computer executable instructions (e.g., one or more programs) recorded on a storage medium (which may also be referred to more fully as a “non-transitory computer-readable storage medium”) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-205530, filed Nov. 26, 2024, which is hereby incorporated by reference herein in its entirety.

What is claimed is:

1. An image processing apparatus having a display unit, comprising:
a memory storing instructions; and
a processor executing the stored instructions causing the image processing apparatus to:
manage a history of states of the image processing apparatus and a history of usage status of the image processing apparatus; and
perform display processing to display, on the display unit, a screen including an information display region that displays either first information indicating an abnormality among the states of the image processing apparatus or second information indicating a history of the usage status of the image processing apparatus, a first operation region that accepts an operation to switch between display of the first information and display of the second information, and a second operation region that accepts an operation to select the first information within the information display region; and
wherein in the display processing, in a case in which the operation to the first operation region is accepted in a state in which both the first information is displayed and the operation to the second operation region has been accepted, third information indicating the first information in a time series and the second information are displayed on a single time series within the information display region.

2. The image processing apparatus according to claim 1, wherein in a case in which the operation to the first operation region is accepted in a state in which both the first information is displayed and the operation to the second operation region has not been accepted, the second information is displayed within the information display region without the first information and the third information being displayed.

3. The image processing apparatus according to claim 1, wherein the first information is displayed within the information display region for each category by being divided into a plurality of different categories; and
wherein the first operation region includes a region that accepts selection of the category.

4. The image processing apparatus according to claim 3, wherein the plurality of different categories is at least two from among parts life, errors, jams, and faults other than the errors and the jams.

5. The image processing apparatus according to claim 1, wherein execution of the stored instructions by the processor further causes the image processing apparatus to, in a case in which an operation in the first operation region to select the second information is accepted, display the second information within the information display region for each category by dividing the second information into a plurality of different categories, and further display, within the screen, a third operation region that accepts selection of the category.

6. The image processing apparatus according to claim 5, wherein in a case in which display of the second information is selected by the operation to the first operation region, the third operation region is displayed within the screen in which the first operation region is displayed.

7. The image processing apparatus according to claim 5, wherein the plurality of different categories is at least two from among temperature, humidity, print count, and cassette operation history.

8. The image processing apparatus according to claim 1, wherein the second information and the third information are displayed on a single time series within a certain period including the time point at which the abnormality occurred.

9. The image processing apparatus according to claim 3, wherein execution of the stored instructions by the processor further causes the image processing apparatus to, when the second information and the third information are displayed on a single time series, control the display period of the second information according to the display period of the third information that is displayed by being selected for each category.

10. The image processing apparatus according to claim 9, wherein the display period of the third information that is displayed by being selected for each category coincides with the display period of the second information.

11. The image processing apparatus according to claim 1, wherein in a case in which a plurality of pieces of abnormality information of the same type exist among the first information, when the second information and the third information are displayed on a single time series, a region that accepts selection of one piece of abnormality information from among the plurality of pieces of abnormality information is displayed, and the third information corresponding to the selected piece of abnormality information is displayed within the information display region.

12. The image processing apparatus according to claim 1, wherein when the second information and the third information are displayed on a single time series, the second information and the third information are displayed in either a graph format or a list format; and
wherein the screen includes a region that accepts an operation to switch between display in the graph format and display in the list format.

13. A method executed by an image processing apparatus having a display unit, comprising:
managing a history of states of the image processing apparatus and a history of usage status of the image processing apparatus; and
performing display processing to display, on the display unit, a screen including an information display region that displays either first information indicating an abnormality among the states of the image processing apparatus or second information indicating a history of the usage status of the image processing apparatus, a first operation region that accepts an operation to switch between display of the first information and display of the second information, and a second operation region that accepts an operation to select the first information within the information display region; and
wherein in the display processing, in a case in which the operation to the first operation region is accepted in a state in which both the first information is displayed and the operation to the second operation region has been accepted, third information indicating the first information in a time series and the second information are displayed on a single time series within the information display region.

14. A non-transitory storage medium storing a program for an image processing apparatus having a display unit causing a computer to perform each step of a method for the image processing apparatus, the method comprising:
managing a history of states of the image processing apparatus and a history of usage status of the image processing apparatus; and
performing display processing to display, on the display unit, a screen including an information display region that displays either first information indicating an abnormality among the states of the image processing apparatus or second information indicating a history of the usage status of the image processing apparatus, a first operation region that accepts an operation to switch between display of the first information and display of the second information, and a second operation region that accepts an operation to select the first information within the information display region; and
wherein in the display processing, in a case in which the operation to the first operation region is accepted in a state in which both the first information is displayed and the operation to the second operation region has been accepted, third information indicating the first information in a time series and the second information are displayed on a single time series within the information display region.
